(19) United States
(12) Patent Application Publication
(10) Pub. No.: US 2008/0107852 A1
(43) Pub. Date: May 8, 2008

(54) Foamed plastic structures

(76) Inventors: Justin D. Rubb, Coraopolis, PA (US); Blain Hileman, New Castle, PA (US); Paul E. Arch, Coraopolis, PA (US)

Correspondence Address: NOVA Chemicals Inc., Westpointe Center, 1550 Coraopolis Heights Road, Moon Township, PA, 15108, US

(21) Appl. No.: 11/594,605

(22) Filed: Nov. 8, 2006

(51) Int. Cl. B32B 3/26; C08F 12/02; C08F 12/34

(52) U.S. Cl. 428/36.5; 521/146; 428/304.4

(57) ABSTRACT

Foamed plastic structures that include one or more foamed plastic bodies containing a polymer matrix that includes one or more polymers formed by polymerizing a monomer mixture that includes vinyl aromatic monomers and divinyl aromatic monomers. The structures formed can include, as non-limiting examples, pallets, containers, stackable containers, produce boxes, seafood shipping containers, geofoam blocks, and insulated concrete forms.

### BACKGROUND OF THE INVENTION

1. Field of the Invention

The present invention is directed to novel foamed plastic structures, such as pallets, containers, produce boxes, geofoam blocks, seafood shipping containers, insulated concrete forms, and the like.

2. Description of the Prior Art

It is known to make various shaped articles from foamed thermoplastic materials such as expandable polystyrene (EPS) by various molding methods. Such articles include pallets, containers, produce boxes, geofoam blocks, seafood shipping containers, insulated concrete forms, and the like.

However, articles molded from EPS often have a limited or shorter than desirable lifespan due to the brittle nature of foamed EPS. For example, parts of the articles often chip or break away due to normal wear and tear, handling and/or while being transported.

For example, a shipping pallet is a well known load-bearing, moveable platform whereon articles are placed for storage and/or shipment. The pallet usually is loaded with a multiplicity of items, such as cartons or boxes. The loaded pallet is movable, usually with the aid of either a pallet truck or a forklift.

Molded foam plastic pallets, for example, those disclosed in U.S. Pat. No. 6,786,992, which include a pallet having an expanded polystyrene core and a layer of high impact polystyrene covering a portion of the core, are known.

Also, U.S. Patent Application Publication No. 2005/0263044 discloses a pallet that includes a shape defining compressible core member, having at least one surface including a convex feature and a core member perimeter; and a thermoplastic shell having a shell interior and a shell edge, where the shell includes a first pliable thermoplastic sheet having an interior shaped by the convex surface of the core member and a first sheet edge extending outside of the core member perimeter, and a second pliable thermoplastic sheet having a second sheet interior and second sheet edge extending outside of the core member perimeter.

Generally, pallets made from foamed plastics, are not as strong as traditional wood pallets and, therefore, break under the load-bearing stress applied during use, making them undesirable.

U.S. Pat. No. 3,968,879 discloses EPS shipping containers that can be stacked. However, under normal handling and wear and tear the containers tend to chip and break during use making them undesirable.

U.S. Pat. Nos. 4,541,540, 4,368,819, 4,197,958, 3,807,194, 3,734,336, and 3,527,373 disclose various containers that include foamed EPS in their construction. However, under normal handling and wear and tear the containers tend to chip and break during use making them undesirable.

U.S. Pat. No. 6,764,250 discloses a method of load reduction on a buried culvert using an EPS block. The EPS blocks are paved in multiple layers on the top surface of the culvert and then, filling earth is banked on the EPS blocks and a final ground level is compacted. However, often the EPS blocks are damaged while being handled and laid in place.

Insulated concrete forms (ICF) made all or in part from molded EPS are known in the art, as disclosed for example in U.S. Pat. Nos. 5,333,429; 5,390,459; 5,566,518; 5,568,710; 5,657,600; 5,709,060; 5,787,665; 5,822,940; 5,845,449; 5,887,401; 6,098,367; 6,167,624; 6,170,220; 6,235,367; 6,314,697; 6,318,040; 6,336,301; 6,363,683; 6,438,918; 6,526,713; 6,588,168; 6,647,686 and 6,820,384; and in U.S. Patent Application Publication Nos. 2002/0116889 and 2003/0005659. However, ICF's made according to these disclosures are prone to form deformation and/or blowout due to pressure exerted by poured concrete. Further, the ICF's are often damaged while being handled and laid in place.

Thus, there is a need in the art for variously shaped articles formed from foamed thermoplastic materials that overcome the problems described above.

### SUMMARY OF THE INVENTION

The present invention provides foamed plastic structures that include one or more foamed plastic bodies containing a polymer matrix that includes one or more polymers formed by polymerizing a monomer mixture that includes vinyl aromatic monomers and divinyl aromatic monomers.

The present invention additionally provides pallets, containers, produce boxes, geofoam blocks, seafood shipping containers, insulated concrete forms that contain the polymer described above.

### DESCRIPTION OF THE DRAWINGS

FIG. 1 shows a perspective view of a pallet that can be made according to the invention;

FIG. 2 shows a perspective view of a pallet that can be made according to the invention;

FIG. 3 shows a perspective view of a pallet that can be made according to the invention;

FIG. 4 shows a perspective view of a container having a sliding cover made according to the invention;

FIG. 5 shows a perspective view of a container and removable cover made according to the invention;

FIG. 6 shows a perspective view of a container and removable cover made according to the invention;

FIG. 7 shows a side elevation view of a shipping container made according to the invention;

FIG. 8 shows an end elevation view of the shipping container shown in FIG. 7;

FIG. 9 shows a perspective view of a stackable box that can be used for transporting fish made according to the invention;

FIG. 10 shows a schematic view illustrating a structure of a construction section of a buried culvert section using EPS blocks made according to the invention;

FIG. 11 shows a perspective view of an insulated concrete form that includes panels made according to the invention;

FIG. 12 shows a top plan view of the insulated concrete form shown in FIG. 11;

FIG. 13 shows a perspective view of a plurality of concrete form ties spanning first and second sidewalls, each made according to the invention, of an insulated concrete form;

FIG. 14 is a perspective view of the form of FIG. 13 with a portion of one sidewall of the form broken away to show the concrete tie embedded within the sidewall of the form;

FIG. 15 shows a perspective view of an insulated concrete form block made according to the invention; and

FIG. 16 shows a perspective view of a pair of the blocks shown in FIG. 15 in a stacked and staggered configuration and their internal features, and further including a plurality of reinforcing rod (“rebar”) disposed within the features of the blocks.

### DETAILED DESCRIPTION OF THE INVENTION

For the purpose of the description hereinafter, the terms “upper”, “lower”, “inner”, “outer”, “right”, “left”, “vertical”, “horizontal”, “top”, “bottom” and derivatives thereof, shall relate to the invention as oriented in the drawing Figures. However, it is to be understood that the invention may assume alternate variations and step sequences except where expressly specified to the contrary. It is also to be understood that the specific devices and processes, illustrated in the attached drawings and described in the following specification, is an exemplary embodiment of the present invention. Hence, specific dimensions and other physical characteristics related to the embodiment disclosed herein are not to be considered as limiting the invention. In describing the embodiments of the present invention, reference will be made herein to the drawings in which like numerals refer to like features of the invention.

Other than where otherwise indicated, all numbers or expressions referring to quantities, distances, or measurements, etc. used in the specification and claims are to be understood as modified in all instances by the term “about”. Accordingly, unless indicated to the contrary, the numerical parameters set forth in the following specification and attached claims are approximations that can vary depending upon the desired properties, which the present invention desires to obtain. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective measurement methods.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “expandable polymer matrix” refers to a polymeric material in particulate or bead form that is impregnated with a blowing agent such that when the particulates and/or beads are placed in a mold and heat is applied thereto, evaporation of the blowing agent (as described below) effects the formation of a cellular structure and/or an expanding cellular structure in the particulates and/or beads and the outer surfaces of the particulates and/or beads fuse together to form a continuous mass of polymeric material conforming to the shape of the mold.

As used herein, the term “polymer” is meant to encompass, without limitation, homopolymers, copolymers and graft copolymers.

As used herein, the terms “(meth)acrylic” and “(meth)acrylate” are meant to include both acrylic and methacrylic acid derivatives, such as the corresponding alkyl esters often referred to as acrylates and (meth)acrylates, which the term “(meth)acrylate” is meant to encompass.

The present invention provides a foam plastic structure that includes one or more foamed plastic bodies containing a polymer matrix that includes one or more polymers formed by polymerizing a monomer mixture that includes vinyl aromatic monomers and divinyl aromatic monomers.

The inventive structures overcome the problems in the prior art by providing a tough foam plastic structure that resists chipping, breaking and otherwise deforming when compared to structure made from EPS in the prior art.

As used herein, the term “foam plastic structure” refers to a molded article that includes component parts, at least some of which are held together in a particular way through the fusion of expandable thermoplastic particles and/or pre-puff beads as described herein resulting from a molding process.

The foam plastic structures are made of a foamed plastic that can be produced by expanding an expandable polymer matrix. The expanded polymer matrix is typically molded from expandable thermoplastic particles. These expandable thermoplastic particles include polymers formed by polymerizing a monomer mixture that includes vinyl aromatic monomers and divinyl aromatic monomers.

In embodiments of the invention, the vinyl aromatic monomers can be selected from styrene, isopropylstyrene, alpha-methylstyrene, nuclear methylstyrenes, chlorostyrene, tert-butylstyrene, vinyl toluene, vinyl xylene, ethyl vinyl benzene, vinyl naphthalene, para-methyl styrene, dibromostyrene and combinations thereof.

In other embodiments of the invention, the divinyl aromatic monomers can be selected from divinyl benzene, divinyl naphthalene, trivinyl benzene, divinyl toluene, divinyl xylene, divinyl alkyl benzenes, divinyl phenanthrene, divinyl biphenyl, divinyl diphenyl methane, divinyl benzyl, divinyl phenyl ether, divinyl diphenyl sulfide; divinyl furan; and combinations thereof.

In additional embodiments of the invention, the monomer mixture can include one or more other monomers selected from conjugated dienes, C₁-C₃₂ alkyl(meth)-acrylates, acrylonitrile, maleic anhydride, C₂-C₃₂ alpha-olefins and combinations thereof.

In particular embodiments of the invention, the vinyl aromatic monomer includes styrene and the divinyl aromatic monomer includes divinyl benzene.

In various embodiments of the invention, the vinyl aromatic monomers are present in the monomer mixture at a level of at least about 50, in some cases at least about 60 and in other cases at least about 70 wt. % and can be present at up to about 99.99, in some cases up to about 99.93, in other cases up to about 99.9, in some instances up to about 99, in other instances up to about 95, and in some circumstances up to about 90 wt. % based on the weight of the monomer mixture. The amount of aromatic monomers present in the monomer mixture can be any value or range between any of the values recited above.

Further to these embodiments, the divinyl aromatic monomers can be present in the monomer mixture at a level of from at least about 0.01, in some cases at least about 0.02 wt. % and can be present at a level of up to about 0.07, in some cases up to about 0.06, and in other cases up to about 0.05 wt. % based on the weight of the monomer mixture. When the amount of divinyl aromatic monomers is too low, the physical property improvements described herein may not be realized. When the amount of divinyl aromatic monomers is too high, the resulting polymer may be difficult or impossible to handle as desired. The amount of divinyl aromatic monomers present in the monomer mixture can be any value or range between any of the values recited above.

When only aromatic monomers and divinyl aromatic monomers are present in the monomer mixture, the total weight percentages of aromatic monomers and divinyl aromatic monomers does not exceed 100 wt. %.

In other embodiments of the invention, the monomer mixture contains other monomers as indicated above. When other monomers are included in the monomer mixture, they are included at a level of from at least about 1, in some cases at least about 5, in other cases at least about 10, in some instances at least about 20 wt. % and can be present in the monomer mixture at up to about 49.99, in some cases up to about 49.93, in other cases up to about 49.9, in some instances up to about 49, in other instances up to about 45, and in some circumstances up to about 40 wt. % based on the weight of the monomer mixture. The amount of other monomers present in the monomer mixture can be any value or range between any of the values recited above.

When other monomers are included in the monomer mixture with aromatic monomers and divinyl aromatic monomers, the total weight percentages of all monomers in total does not exceed 100 wt. %.

The monomer mixture can be polymerized in any conventional manner. Generally the monomer mixture can be polymerized using a thermal and/or free radical initiation. The process can be a bulk polymerization in which the monomer mixture and, optionally, a minor amount of a diluent such as ethyl benzene, forms the reaction medium. Alternatively, the process can be a suspension or emulsion process in which the monomer mixture is suspended or dispersed in a different, non-hydrocarbon, typically aqueous phase and the polymerization takes place in the dispersed monomer droplets (e.g. suspension) or in a micelle into which monomer diffuses from the monomer droplets (e.g. emulsion).

According to one aspect of the present invention in which the polymer is prepared in a suspension or emulsion, the monomer mixture is suspended in water, from about 50 to 500 parts (in some cases about 75 to 250 parts) by weight, per 100 parts by weight of the monomer mixture using an effective amount of one or more suitable suspending agents. Any of the suspending agents useful in the suspension polymerization of vinyl aromatic polymers can be used. Non-limiting examples of suitable suspending agents include finely divided water-insoluble inorganic substances such as tricalcium phosphate and the like as well as water-soluble polymers such as polyvinyl alcohol, alkyl aryl sulfonates, hydroxyethyl cellulose, polyacrylic acid, methyl cellulose, polyvinyl pyrrolidone, and low molecular weight (often Mw less than about 5,000) polyalkylene glycols (e.g. polyethylene glycols and polypropylene glycols) and the like. Auxiliary suspending agents such as sodium linear alkylbenzene sulfonates can also be employed. The use of tricalcium phosphate together with a sodium linear alkylbenzene sulfonate is particularly useful. The amount of the suspending agent necessary will vary depending on a number of factors but will generally be from about 0.01 to 1 part by weight per 100 parts by weight of the monomer mixture. One or more surfactants such as a polyoxyalkylene derivative of sorbitan monolaurate or other fatty acid ester, an ethylene oxide/propylene oxide block copolymer, or other non-ionic or anionic surface active agent can be added to the aqueous suspension if desired. In embodiments of the invention, the amount of surfactant is from about 0.01 to 1 part by weight per 100 parts by weight of monomer.

In addition to the monomers, the aqueous suspension can include a free radical initiator or free radical initiator system. The free radical generator can be a peroxide such as hydrogen peroxide or benzoyl peroxide, or a persulfate initiator.

The reaction mixture is heated to initiate polymerization, either thermally or by a free radical catalyst. After the monomers are polymerized to form particles or beads (generally resulting from the suspension process) or microparticles (generally resulting from the emulsion process), they can be separated from the aqueous phase and washed.

In many embodiments of the invention, the amount of aromatic monomers and divinyl aromatic monomers and any other monomers in the monomer mixture can be varied to alter the physical properties and processing characteristics of the resulting polymer. Non-limiting examples of physical properties that can be altered in the resulting polymer include molecular weight, glass transition temperature, Young's modulus, compressive yield, tensile yield, maximum strain at fracture, and ultimate strength. Non-limiting examples of processing characteristics that can be altered include the expansion rate, minimum achievable density, temperature sensitivity, and molding cycle times of the resulting expandable thermoplastic particles as well as the appearance of molded parts.

In particular embodiments of the invention, higher divinyl aromatic monomer levels in the monomer mixture tend to increase the physical properties of the resulting polymer and to decrease the expandability and molding rates of the resulting expandable thermoplastic particles.

In embodiments of the invention, the expandable polymer matrix can be a blend of polymers formed by polymerizing a monomer mixture that includes vinyl aromatic monomers and divinyl aromatic monomers and any other suitable thermoplastic homopolymers or copolymers, and/or elastomeric materials. Particularly suitable for use are homopolymers derived from vinyl aromatic monomers including styrene, isopropylstyrene, alpha-methylstyrene, nuclear methylstyrenes, chlorostyrene, tert-butylstyrene, and the like, as well as copolymers prepared by the copolymerization of at least one vinyl aromatic monomer as described above with one or more other monomers, non-limiting examples being divinylbenzene, conjugated dienes (non-limiting examples being butadiene, isoprene, 1,3- and 2,4-hexadiene), alkyl methacrylates, alkyl acrylates, acrylonitrile, and maleic anhydride, wherein the vinyl aromatic monomer is present in at least 50% by weight of the copolymer.

As used herein, the term “elastomeric material” refers to natural or synthetic rubber or rubberoid materials, which have the ability to undergo deformation under the influence of a force and regain its original shape once the force has been removed. Suitable elastomeric materials include, but are not limited to natural rubber, homopolymers of butadiene, homopolymers of isoprene, random, block, AB diblock, ABA triblock, or multi-block copolymers of a conjugated diene with one or monomers selected from styrenic monomers, partially hydrogenated styrene, vinyl cyclohexane, (meth)acrylonitrile, C₁-C₃₂ linear, branched, or cyclic alkyl(meth)acrylate monomers (as described above) and combinations thereof.

In an embodiment of the invention, the elastomeric materials include a polymer containing styrenic monomer units and conjugated diene units. The polymer contains one or more blocks, where each block includes styrenic monomer units or conjugated diene units. If a block contains only one type of monomer unit, it can be termed a “monoblock”. If it contains both types of monomer units, it can be a random block, a tapered block, a stepwise block, or any other type of block.

In an embodiment of the invention, the elastomeric materials include one or more block copolymers selected from diblock and triblock copolymers of styrene-butadiene, styrene-butadiene-styrene, styrene-isoprene, styrene-isoprene-styrene, partially hydrogenated styrene-isoprene-styrene. Examples of suitable block copolymers include, but are not limited to, the STEREON® block copolymers available from the Firestone Tire and Rubber Company, Akron, Ohio; the ASAPRENE™ block copolymers available from Asahi Kasei Chemicals Corporation, Tokyo Japan; the KRATON® block copolymers available from Kraton Polymers, Houston, Tex.; and the VECTOR® block copolymers available from Dexco Polymers LP, Houston, Tex.

In a particular embodiment of the invention, the styrenic monomer-conjugated diene copolymer is a random copolymer or a block copolymer containing styrene blocks and butadiene blocks. Copolymers of styrene and butadiene are typically clear resins known in the art as SBC resins and provide both high clarity and good stiffness properties. Non-limiting examples of SBC resins include the styrene-butadiene copolymers available under the K-Resin® trademark (Chevron Phillips Chemical Co., The Woodlands, Tex.).

When other polymers are used in a blend with the present vinyl aromatic monomer/divinyl aromatic monomer copolymers, the other polymers can impact the physical properties of the resulting foamed article. Non-limiting examples of the impact other polymers can have in the present blend include improved cushioning properties, improved fracture toughness, increased ductility, increased compressive stress, increased puncture resistance, improved tear performance, improved tensile performance, and altered temperature sensitivity. These properties can be varied by adjusting the blend ratio in order to meet the requirements of a desired application. The blend ratio of vinyl aromatic monomer/divinyl aromatic monomer copolymers to other polymers can be from 1:5 to 5:1, in some cases from 1:5 to 2:1, in other cases from 1:5 to 1:1 and in some instances from 1:10 to 1:1 based on the weight of the blend.

In embodiments of the invention, the expandable thermoplastic particles are expandable particles containing polymers formed by polymerizing a monomer mixture that includes vinyl aromatic monomers, divinyl aromatic monomers and optionally other monomers. These particles can be in the form of beads, granules, or other particles convenient for the expansion and molding operations. The particles can be formed by polymerization in an aqueous suspension process to produce essentially spherical and are useful for molding the structures described herein below. These particles can be screened so that their size ranges from about 0.008 inches (0.2 mm) to about 0.16 inches (4 mm).

In an embodiment of the invention, resin beads (unexpanded) containing any of the polymers or polymer compositions described herein have a particle size of at least 0.2 mm, in some situations at least 0.33 mm, in some cases at least 0.35 mm, in other cases at least 0.4 mm, in some instances at least 0.45 mm and in other instances at least 0.5 mm. Also, the resin beads can have a particle size of up to about 4 mm, in some situations up to about 3.5 mm, in other situations up to about 3 mm, in some instances up to 2 mm, in other instances up to 2.5 mm, in some cases up to 2.25 mm, in other cases up to 2 mm, in some situations up to 1.5 mm and in other situations up to 1 mm. The resin beads used in this embodiment can be any value or can range between any of the values recited above.

The average particle size and size distribution of the expandable resin beads or pre-expanded resin beads can be determined using low angle light scattering, which can provide a weight average value. As a non-limiting example, a Model LA-910 Laser Diffraction Particle Size Analyzer available from Horiba Ltd., Kyoto, Japan can be used

As used herein, the terms “expandable thermoplastic particles” or “expandable resin beads” refers to a polymeric material in particulate or bead form that is impregnated with a blowing agent such that when the particulates and/or beads are placed in a mold or expansion device and heat is applied thereto, evaporation of the blowing agent (as described below) effects the formation of a cellular structure and/or an expanding cellular structure in the particulates and/or beads. When expanded in a mold, the outer surfaces of the particulates and/or beads fuse together to form a continuous mass of polymeric material conforming to the shape of the mold.

As used herein, the terms “pre-expanded thermoplastic particles,” “pre-expanded resin beads,” or “pre-puff” refers to expandable resin beads that have been expanded, but not to their maximum expansion factor and whose outer surfaces have not fused. As used herein, the term “expansion factor” refers to the volume a given weight of resin bead occupies, typically expressed as cc/g. Pre-expanded resin beads can be further expanded in a mold where the outer surfaces of the pre-expanded resin beads fuse together to form a continuous mass of polymeric material conforming to the shape of the mold.

The expandable thermoplastic particles can be impregnated using any conventional method with a suitable blowing agent. As a non-limiting example, the impregnation can be achieved by adding the blowing agent to the aqueous suspension during the polymerization of the polymer, or alternatively by resuspending the polymer particles in an aqueous medium and then incorporating the blowing agent as taught in U.S. Pat. No. 2,983,692. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g., CFC's and HCFC's, which boil at a temperature below the softening point of the polymer chosen. Mixtures of these aliphatic hydrocarbon blowing agents can also be used.

Alternatively, water can be blended with these aliphatic hydrocarbons blowing agents or water can be used as the sole blowing agent as taught in U.S. Pat. Nos. 6,127,439; 6,160,027; and 6,242,540 in these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The impregnated thermoplastic particles are generally pre-expanded to a density of at least 0.5 lb/ft³, in some cases at least 0.75 lb/ft³, in other cases at least 1.0 lb/ft³, in some situations at least 1.25 lb/ft³, in other situations at least 1.5 lb/ft³, and in some instances at least about 1.75 lb/ft³. Also, the density of the impregnated pre-expanded particles can be up to 12 lb/ft³, in some cases up to 10 lb/ft³, and in other cases up to 5 lb/ft³. The density of the impregnated pre-expanded particles can be any value or range between any of the values recited above. The pre-expansion step is conventionally carried out by heating the impregnated beads via any conventional heating medium, such as steam, hot air, hot water, or radiant heat. One generally accepted method for accomplishing the pre-expansion of impregnated thermoplastic particles is taught in U.S. Pat. No. 3,023,175.

The impregnated thermoplastic particles can be foamed cellular polymer particles similar to those taught in U.S. Patent Application Pub. No. 2002/0117769, the relevant teachings of which are incorporated herein by reference. The foamed cellular particles can be polystyrene that are pre-expanded and contain a volatile blowing agent at a level of less than 14 wt. %, in some situations less than 8 wt. %, in some cases ranging from about 2 wt. % to about 7 wt. %, and in other cases ranging from about 2.5 wt. % to about 6.5 wt. % based on the weight of the polymer.

In embodiments of the invention, the monomer mixture is polymerized to form an interpolymer of a polyolefin and in situ polymerized vinyl aromatic monomers, divinyl aromatic monomers and optionally other monomers. Methods for forming such interpolymers of a polyolefin and in situ polymerized monomers are disclosed, as non-limiting examples, in U.S. Pat. Nos. 4,303,756, 4,303,757 and 6,908,949, the relevant portions of which are herein incorporated by reference.

The expanded polymer matrix can include customary ingredients and additives, such as flame retardants, pigments, dyes, colorants, plasticizers, mold release agents, stabilizers, ultraviolet light absorbers, mold prevention agents, antioxidants, termiticides and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention the pigment is carbon black. In another particular embodiment of the invention the pigment is graphite.

The pre-expanded particles or “pre-puff” are usually heated in a closed mold to form the present structures.

A particular advantage of the structures made according to the present invention are the physical properties of the expanded polymer matrix foam that makes up the structure. The inclusion of the divinyl aromatic monomers in the monomer mix provides a polymer structure that can vary from being slightly branched to mildly crosslinked. The resulting three dimensional polymer structure provides a tougher foam that more effectively resists chipping, breaking or other deformations.

In embodiments of the invention, the superior properties of the foam that makes up the present foamed plastic structures can include Flex Strength, measured as Flex Strength at 5% Strain according to ASTM C 203-05 using a Model 4204 Universal Test Machine, Instron Corporation, Norwood, Mass. In many embodiments of the invention, the Flex Strength at 5% Strain of the expanded polymer matrix foam that makes up the present structures is at least 10% higher, in some cases 15% higher than similarly molded structures made from the same polymer composition not containing the divinyl aromatic monomers.

In other embodiments of the invention, the superior properties of the foam that makes up the present foamed plastic structures can include Compressive Strength, measured as Compressive Strength at 10% Strain according to ASTM D 1621-04 using an Model 4204 Universal Test Machine with a compression cage at a crosshead rate of 0.1 inch per minute based on 0.1 inch per minute for each 1 inch of specimen thickness. In many embodiments of the invention, the Compressive Strength at 10% Strain of the expanded polymer matrix foam that makes up the present structures is at least 10% higher, in some cases 15% higher than similarly molded structures made from the same polymer composition not containing the divinyl aromatic monomers.

In additional embodiments of the invention, the superior properties of the foam that makes up the present foamed plastic structures can include Tear Strength, measured according to ASTM D 3575-00 (Suffix Letter G), which requires following ASTM D 624-00 using Die C. In many embodiments of the invention, the Tear Strength of the expanded polymer matrix foam that makes up the present structures is at least 10% higher, in some cases 15% higher than similarly molded structures made from the same polymer composition not containing the divinyl aromatic monomers.

In many embodiments of the invention, the superior properties of the foam that makes up the present foamed plastic structures can include Tensile Strength, measured according to ASTM D 3575-00 (Suffix Letter T), which requires following ASTM D 412-98a (Reapproved 2002) using Die A. In many embodiments of the invention, the Tensile Strength of the expanded polymer matrix foam that makes up the present structures is at least 10% higher, in some cases 15% higher than similarly molded structures made from the same polymer composition not containing the divinyl aromatic monomers.

In a number of embodiments of the invention, the superior properties of the foam that makes up the present foamed plastic structures can include the Compressive Creep Properties of the foam, measured as a Steady State Compressive Creep Rate according to ASTM D 2990-01. The static stress is calculated for each sample based on the load and load area. Deformation is recorded electronically for 22 days. The steady-state compressive creep rate is calculated from data between 108 and 528 hours. In many embodiments of the invention, the Steady State Compressive Creep Rate of the expanded polymer matrix foam that makes up the present structures is at least 5% lower and in some cases 8% lower than similarly molded structures made from the same polymer composition not containing the divinyl aromatic monomers.

As indicated above, the present invention can be used to make various structures. In embodiments of the invention, the structure can be a pallet. As a non-limiting example, the present pallet includes a base and a plurality of legs extending from one side of the base.

In an embodiment of the invention shown in FIG. 1, pallet 8 includes an expanded polymer matrix core 10, which is in the general shape of a rectangular slab with an edge 12 that has a width 14 which can be from 1 to 25 cm, in some cases from 2 to 20 cm and in other cases from 2.5 to 15 cm. Core 10 has a topside 16 that can be from 75 to 150 cm, in some cases from 90 to 140 cm and in other cases from 100 to 130 cm long and from 65 to 140 cm, in some cases from 80 to 130 cm and in other cases from 90 to 120 cm forty inches wide. Bottom side 18 of core 10 includes a plurality of legs (only 20, 22, 24, 26 and 28 are shown) from 8 to 15 cm, in some cases from 9 to 13 cm long extending from bottom side 18.

The legs and bottom side 18 define spaces, as non-limiting examples 30, 32, 34, and 36, proximate to edge 12. Spaces 30, 32, 34, and 36 separate legs 28 and 20, legs 20 and 22, legs 22 and 24 and legs 24 and 26 respectively, from the edge 12.

In an embodiment of the invention, spaces 30, 32, 34, and 36 are adapted to receive the tongues of a forklift truck. As a non-limiting example, a first tongue of a forklift can be placed under and along the length of bottom side 18 between leg 28 and leg 20 and a second tongue of a forklift can be placed under and along the length of bottom side 18 between leg 20 and leg 22. When the forklift truck lifts the first and second tongues, a surface of each tongue contacts the surface of bottom side 18 and acts to lift the pallet and any articles stacked on topside 16.

Because core 10 is made from the above-described expanded polymer matrix, it has sufficient structural strength to be used as a pallet or other load bearing platform.

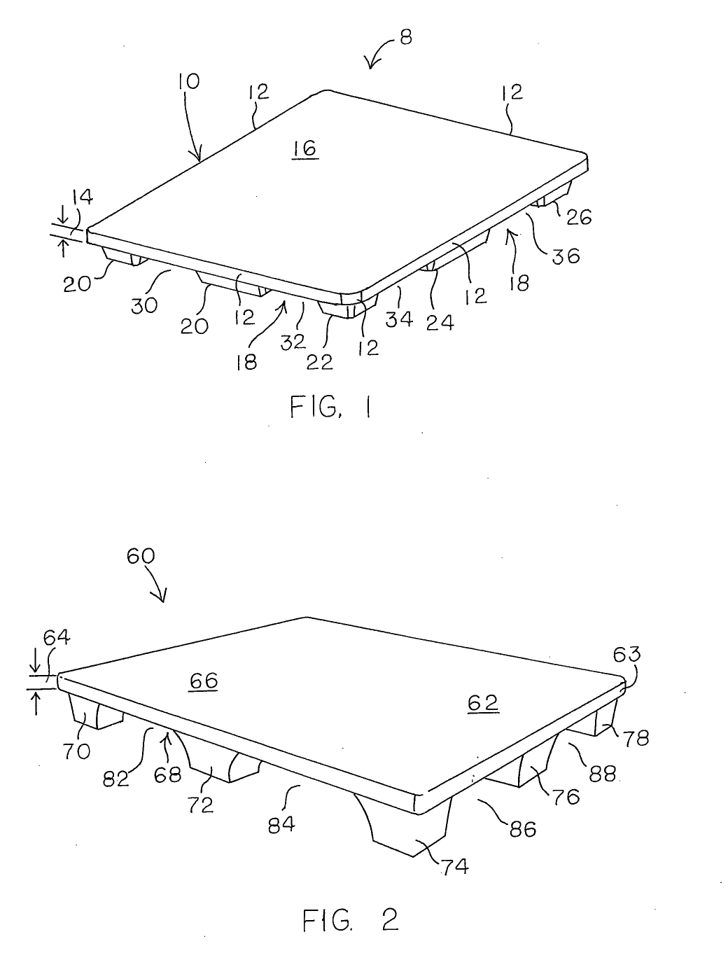

In another example according to this embodiment of the invention shown in FIG. 2, a pallet 60 includes an expanded polymer matrix core 62, which is in the general shape of a rectangular slab with an edge 63 that has a width 64 which can be from 1 to 25 cm, in some cases from 2 to 20 cm and in other cases from 2.5 to 15 cm. Core 62 has a topside 66 that can be from 75 to 150 cm, in some cases from 90 to 140 cm and in other cases from 100 to 130 cm long and from 65 to 140 cm, in some cases from 80 to 130 cm and in other cases from 90 to 120 cm forty inches wide. A bottom side 68 of core 210 include a plurality of legs (only legs 70, 72, 74, 76 and 78 are shown) that can be from 8 to 15 cm, in some cases from 9 to 13 cm long extending from bottom side 68.

Legs 70, 72, 74, 76 and 78 and bottom side 68 define spaces 82, 84, 86, and 88 proximate to edge 63. Spaces 82, 84, 86, and 88 separate legs 70 and 72, legs 72 and 74, legs 74 and 76, and legs 76 and 78 respectively.

In an embodiment of the invention, spaces 82, 84, 86, and 88 are adapted to receive the tongues of a forklift truck. As a non-limiting example, a first tongue of a forklift can be placed under and along the length of bottom side 68 between leg 70 and leg 72 and a second tongue of a forklift can be placed under and along the length of bottom side 68 between leg 72 and leg 74. When the forklift truck lifts the first and second tongues, a surface of each tongue contacts the surface of bottom side 68 and acts to lift the pallet and any articles stacked on topside 66.

Because core 62 is made from the above-described expanded polymer matrix, it has sufficient structural strength to be used as a pallet or load bearing platform.

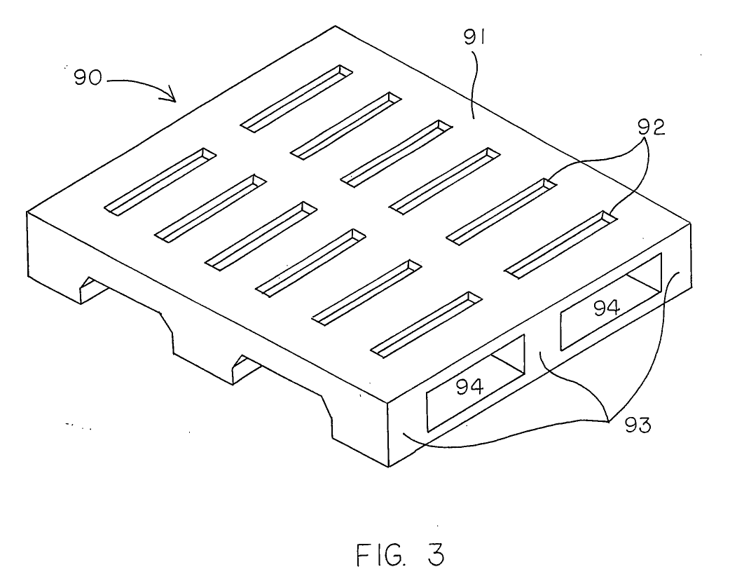

A further pallet example according to this embodiment of the invention is shown in FIG. 3 where pallet 90 includes a top deck 91 which is optionally perforated with openings 92 for weight reduction and/or passage of air. The pallet deck is buttressed by elongated runners 93. Runners 93 are formed integrally with top deck 91 and create walls. Runners 93 are notched to allow a fork lift to enter perpendicular to runner 93. The bottom of runners 93 are joined to bottom supports 94, which run perpendicular to runners 93.

In other embodiments of the invention, the foamed plastic structure can be a container. As a non-limiting example, the container is a stackable container that includes a bottom wall, four side walls extending upwardly from the peripheral edges of the bottom wall, and flanges extending along the upper edges of at least two opposite side walls and inwardly therefrom, where the flanges are adapted to receive a cover.

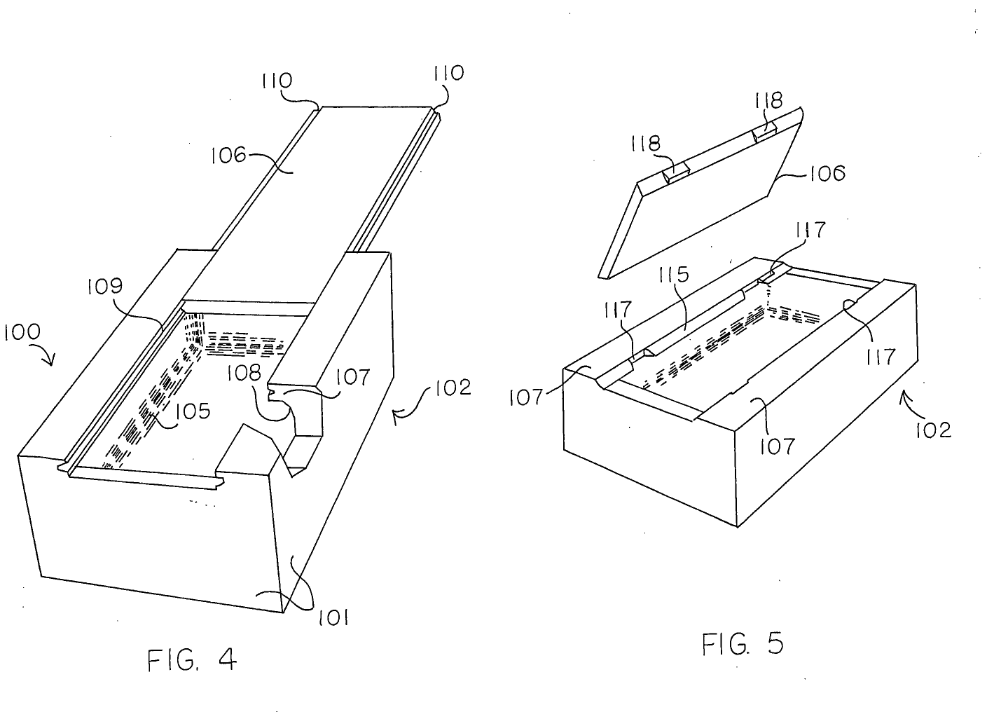

More particularly, FIG. 4 shows container 100 that includes sliding cover 106. Container 100 can have its outside shaped as a rectangular parallelepiped and can include four side walls 101 and bottom 102. Optionally, along the peripheral edges of bottom 102 can extend a bottom edge internal fillet-like reinforcement between the bottom and the side walls.

According to embodiments of the invention, both the longer side walls are provided respectively, along their upper edge, with a flange 107 projecting inwardly of the container. The lower part of flange 107 and the internal face of the corresponding side wall form a corner in which there is a fillet-like reinforcement 108 symmetrical to reinforcement 105 at the bottom of the side wall. The reinforcements 108 and 105 have concave faces. After withdrawal from a mould, container 100 possesses a smooth surface crust having higher mechanical characteristics than those of the inside of the mass. This crust assists the function of reinforcement 108 and prevents flange 107 from collapsing or breaking after an impact or an abnormal downward pressure. Each flange 107 can be formed on its edge with a longitudinal groove 109 extending over the whole length of flange 107.

Cover 106 is provided on each of its side edges with a rib 110 having a profile complementary to that of groove 109 which acts as a slide way for the cover.

FIG. 5 shows another embodiment where container 101 is provided with an upper flange portion on both its longer sides, and notches for receiving studs on the cover. Thus, in container 101, flange 107 extends over the whole upper periphery of the container. Edge 115 of flange 107 is upwardly and outwardly bevelled, the edges of the four sides of the cover can have a complementary downwardly and inwardly bevelled profile. The bevelled edge of each of two opposite flange portions can include notches 117. Studs 118, shaped complementarily to notches 117, are provided on the periphery of cover 106 for reception in notches 117. Cover 106 can thus put in place and taken out vertically.

The containers according to this embodiment can be stacked and stored side by side to form compact blocks in warehouses, store-rooms in ships railway or road trucks or on the pallets described above. In this case, the improved buckling strength and tearing strength as measured using the techniques described above, constitute an important improvement as the limit, in terms of stacked containers or in terms of height of the stack, beyond which it is no longer possible to pile up containers without a risk of tearing or rupture is significantly increased.

In another exemplary container according to this embodiment, the foamed plastic structure can be a container that includes a container portion having bottom and side walls, the upper periphery of the container side walls supporting an upwardly extending tongue therearound having a cross section with upwardly converging side surfaces; and a closure portion having a lid panel that includes a flange therearound, the flange in cross section comprising two downwardly extending legs defining therebetween a tongue-receiving groove.

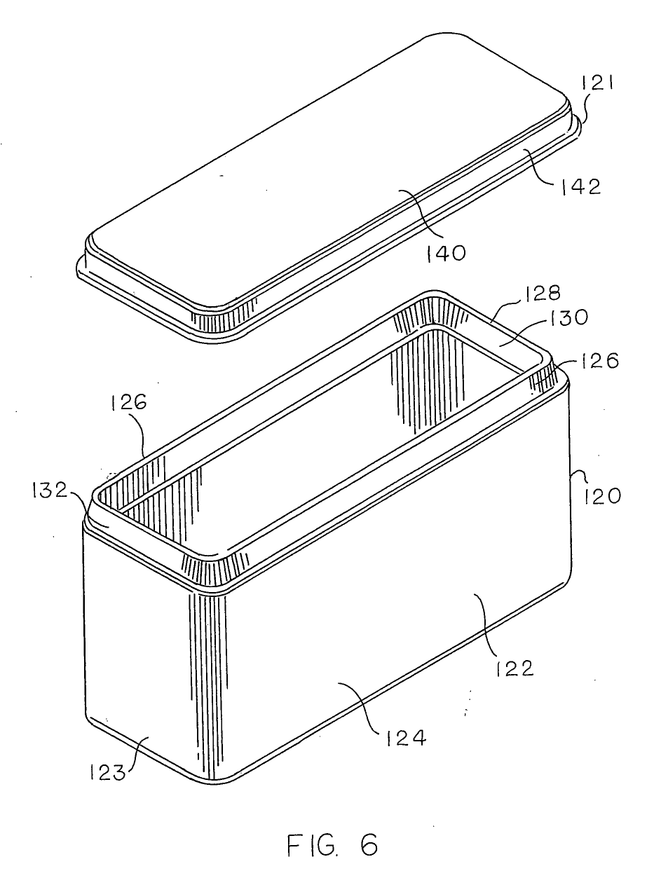

More particularly FIG. 6 shows container 120 and closure 121. Container 120 includes sidewalls such as wall 122 and wall 123, having a bottom wall 124, and having an upwardly extending tongue 126 all the way around the upper periphery of sidewalls 122 and 123. Tongue 126 can be of truncated cross sectional shape having an upper surface 128, and having two upwardly converging side surfaces 130 and 132. Each of the side surfaces 130 and 132 lie at an angle to vertical, although it is not necessary that one of the side surfaces be inclined at the same angle as the other side surface.

Closure portion 121 can include a lid panel 140 having an internal recess (not shown). The panel has a downwardly bifurcated flange 142 extending all the way around it, and the flange divided into inner and outer downwardly extending legs (not shown) defining a tongue receiving groove between them. The angle of the downwardly extending legs must be less than the angle formed by side surfaces 130 and 132 in order for the lid 140 remain in closed position.

As another non-limiting example to this embodiment, the container can include a top part, a bottom part and a cooperative mating means.

The bottom part can have a bottom wall, spaced generally parallel side walls and spaced generally parallel end walls. The side walls of the bottom part can have vertical outer surfaces with tapered surfaces extending inwardly adjacent the lower portions thereof. The side walls of the bottom part can have openings extending through the side walls of the bottom part and the tapered surfaces of the side walls of the bottom part. The tapered surfaces on the side walls of the bottom part can have a height so that the openings in the bottom part extend solely through the tapered surfaces of the side walls of the bottom part.

The top part can include a top that has a top wall, spaced generally parallel side walls and spaced generally parallel end walls. The side walls of the top part can have vertical outer surfaces with tapered surfaces extending inwardly adjacent the upper portions thereof. The side walls of the top part can have openings extending through the side walls of the top part and the tapered surfaces of the side walls of the top part. The tapered surfaces on the side walls of the top part have a height so that the openings in the top part extend solely through the tapered surfaces of the side walls of the top part.

The cooperative mating means is typically carried by the bottom and top parts whereby the top part is releasably secured to the bottom part to form an enclosed volume within the bottom and top parts, which is ventilated by the openings in bottom and top parts.

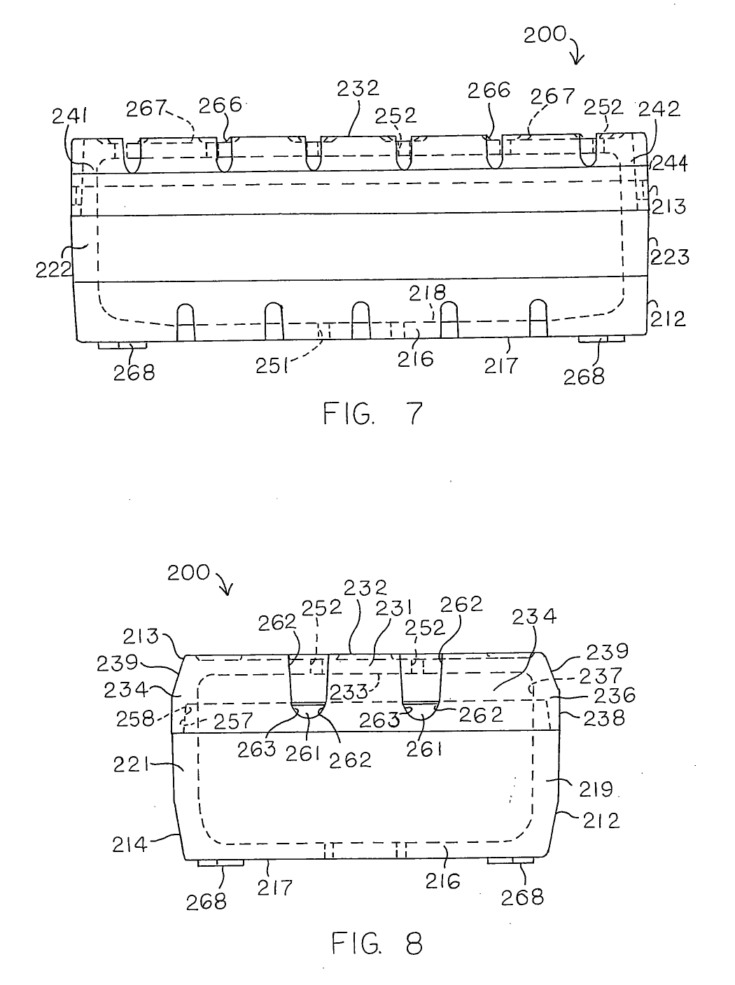

More particularly, as shown in FIGS. 7 and 8, container 200 includes a bottom part 212 and a top part or lid 213. The bottom and top parts 212 and 213 are unitary and are formed from the expandable polymer matrix described herein.

Bottom part 212 includes a bottom wall 216 which lies in a plane and has a generally planar outer surface 217 and an inner surface 218 which can be generally curved upwardly in its outer extremities. Bottom part 212 can also include spaced generally parallel and generally vertical side walls 219 and 221 which adjoin bottom wall 216 and a pair of spaced generally parallel and vertical end walls 222 and 223 which also adjoin bottom wall 216 and side walls 219 and 221 and extend generally at right angles to side walls 219 and 221. Side walls 219 and 221 are provided with inner surfaces, which are generally vertical. The lower extremities of side walls 219 and 221 can be inclined inwardly so that the bottom part of the container is provided with an inwardly tapered portion which extends the length of the bottom part on both sides of the bottom part. End walls 222 and 223 are provided with generally vertical inner surfaces and generally vertical outer surfaces.

Top part or lid 213 includes a top wall 231, which generally lies in a plane and is provided with an outer generally planar surface 232 and an inner generally planar surface 233. A pair of spaced generally parallel, vertically depending side walls 234 and 236 adjoin top wall 231 and are formed integral therewith. Side walls 234 and 236 are provided with generally vertical inner surfaces 237 and outer surfaces 238. Top part or cover 213 can also include spaced generally parallel depending end walls 241 and 242 which adjoin bottom wall 216 and extend at right angles to the side walls. End walls 241 and 242 are provided with generally planar vertical inner surfaces and outer surfaces 244. Outer surface 238 is provided with an upwardly and inwardly inclined surface portion 239.

Four holes 251 arranged on the corners of a square are centrally disposed within bottom wall 216 and extend through the bottom wall 216. A plurality of holes 252 are provided in top wall 231 and extend therethrough. Holes 252 are spaced apart and are provided in two parallel rows extending longitudinally of top wall 231.

Cooperative mating means is carried by the bottom and top parts 212 and 213 whereby the top part is releasably secured to the bottom part to form an enclosed volume within the bottom and top parts. This cooperative mating means takes the form of an outwardly facing recess 257 formed on the upper portion of the bottom part and extends outwardly through the outer surfaces of the side walls 219 and 221 and the end walls 222 and 223. Similarly, an inwardly and downwardly facing recess 258 is formed in the lower extremity of top part 213. Recess 258 extends through the inner surfaces of the side walls 219 and 221 and the end walls 222 and 223. Recesses 257 and 258 are sized in such a manner so that they recess into each other so that smooth inner surfaces are provided for the enclosed volume and smooth outer surfaces are provided for the container.

Means can be provided for releasably locking top part 213 to bottom part 212 and can include a pair of spaced protrusions 261 which are formed integral with end walls 222 and 223 of bottom part 212 and extend into recess 257. Protrusions 261 can be in the form of semi-circular portions. Protrusions 261 are adapted to seat in semi-circular recesses 262 which are formed in end walls 241 and 242 of top part 213. Recesses 262 can be semi-circular at their lower extremity but are elongate and extend through the top of top part 213 so that the recesses in effect are elongate with semi-circular bottom portions. Recesses 262 are formed in such a manner so that there are provided semi-circular openings 263, which open through the lower portion of top part 213 and into recess 258 so that they can receive the spaced protrusions 261. Thus, the top part can be moved downwardly over the protrusions 261 so that the protrusions snap into place into the semi-circular holes 263 to lock top part or cover 213 firmly in place.

In the event it is desired to remove the cover, the upper portion of one of the end walls 222 is pressed inwardly as by hand to thereby permit protrusion 261 to clear the lower extremities of top part 213 so that the cover can be removed. It should be appreciated that protrusions 261 can be formed on the top part and the semi-circular holes 263 formed in the other part if desired.

Cooperative stacking means is carried by the bottom and top parts and is adapted to mate with containers of the same type so that the containers may be stacked with the top part of one container engaging the bottom part of another container and the bottom part of another container for inhibiting substantial lateral and longitudinal movement of the containers with respect to each other.

The cooperative stacking means can include a plurality of spaced parallel rows of recesses 266 extending in one direction in the outer surface of one of the parts, namely top part 213. Recesses 266 are provided with enlarged portions 267 which are generally square in shape and which are spaced longitudinally of recesses 266. Thus, two of the enlarged portions are provided at the outer extremities of recesses 266, whereas the other two enlarged portions are intermediate the ends of the recesses. It will be noted that the two rows of holes 252 can be centrally disposed in the two enlarged portions 267 of recesses 266. In addition, there can be provided pairs of cross recesses (not shown) which can extend between the inner enlarged portions of the two outermost recesses 266 on opposite ends of top part 213.

The cooperative stacking means includes raised portions provided on the outer surface of the bottom wall of the bottom part 12. The raised portions or protrusions 268 are generally right-angle in shape. Right-angle protrusions 268 can be provided with arcuate outer surfaces and arcuate inner surfaces. Protrusions 268 can be shaped in such a way and have such a size so that they can readily fit into the enlarged portions 267 of recesses 266. Protrusions 268 can be provided adjacent the four corners of the outer surface of bottom wall 216. This facilitates stacking of the containers as hereinafter described.

The containers, as hereinbefore described, can be formed in such a manner so that they can readily be stacked one upon the other as, for example, upon a the pallets shown in FIGS. 1-3.

As a further non-limiting example to this embodiment, the container can be a transport box that includes side walls and end walls and a bottom, the side walls each having a vertical portion and an inwardly inclined upper portion, the top edge of the upper portion being horizontally turned outwardly forming a board-like support with its outer margin bent downwardly, a plurality of spaced vertical stiffening webs extending between the board-like support and the inclined upper portion, means forming tubular vertical reinforced corners at the junctures of the side and end walls, the tubular corners being closed at their tops, and a plurality of knobs on the upwardly facing surface of the board-like supports and ribs on the bottom of the box fitting between the knobs when the boxes are stacked.

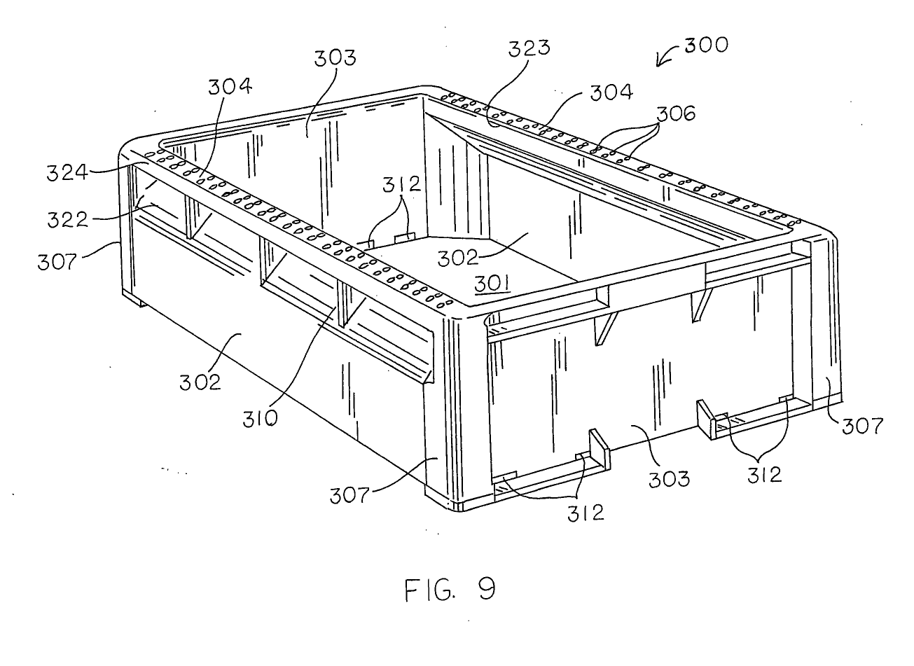

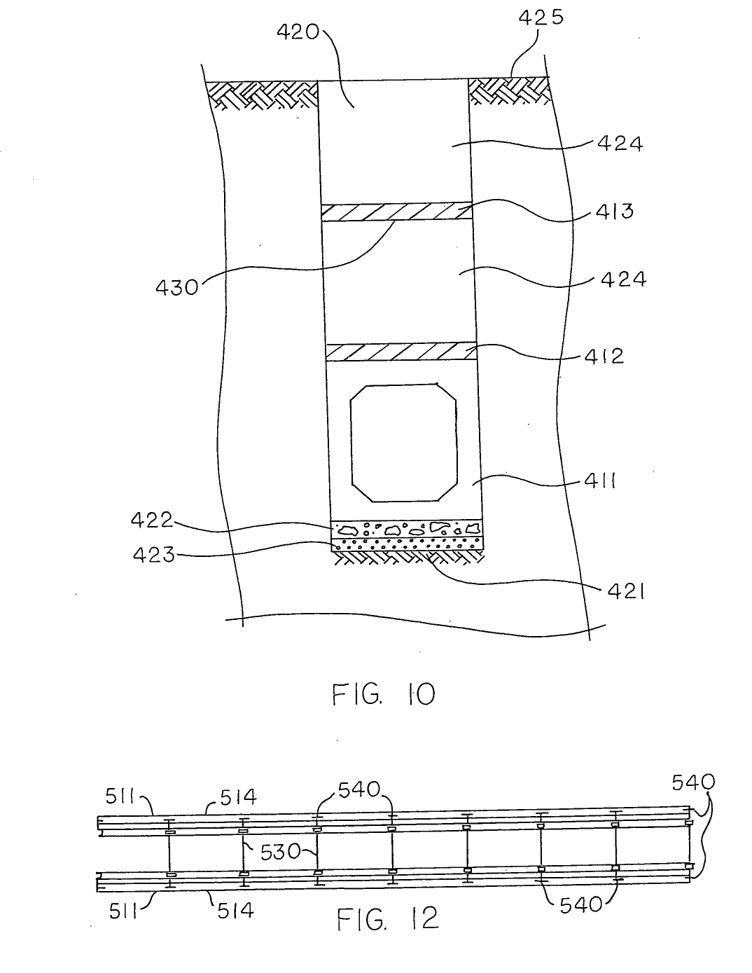

More particularly, as shown in FIG. 9, fishing box 300 includes side walls 302, end walls 303, and an imperforate bottom 301 sloping downward from a central transverse ridge toward a plurality of drainage slots 312 through end walls 303 where end walls 303 join bottom 301. Imperforate bottom 301 prevents waste water or other liquids flowing or dripping from the fish in box 300 from flowing into boxes stacked below. Slots 312 allow water to escape from box 300 only at the outer periphery of bottom 301 where it flows down the outside of boxes stacked below. The sloping of bottom 301 improves drainage of liquids from the box by way of slots 312. Although drainage slots 312 are provided only in end walls 303, it will be readily apparent to those skilled in the art that similar drainage slots can be additionally or alternatively provided in side walls 302. In the event that drainage slots are provided in all four walls, bottom 301 can be modified to slope downward from a central point toward all four walls.

In order to provide boxes according to the invention with the necessary strength and to be able to stress the upper board in use it may be necessary to reinforce the upper boards and the walls effectively. In the shown embodiment this is achieved by molding the upper portions of side walls 302 in such a way that suitable reinforcing portions are formed. The side walls 302 can bend inwards to form an inclined portion 322. They can then bend vertically upwards to form a short portion 323, which then turns into the horizontal frame-like upper board 304. The outer edge of upper board 304 can bend downwards, so as to form a partially vertical reinforcing edge or flange 324 substantially in the plane of the lower vertical portion of side wall 302.

The same applies to the vertical, tube shaped corner reinforcements 307.

In addition to the mentioned side portions 322, 323 and the flanges 324 the upper boards 304 can on one or several locations have vertical ribs or reinforcing webs 310 along the side walls. Said ribs or webs are also manufactured in one piece with the box during the moulding operation.

With side walls 302 shaped as described above, an effective reinforcement of the upper boards 304 is achieved. It is thus possible to walk on said boards, when the fishing boxes are, for instance, stowed away in the hold of a ship or are handled otherwise. As known, upper boards of this kind are necessary for transport boxes for fish, especially on board of ships.

Although in the embodiment shown only side walls 302 have special reinforcing upper portions, it will be readily apparent to those skilled in the art that end walls 303 can be similarly molded if desired.

To facilitate vertical stacking of the boxes, upper boards 304 are provided with a plurality of knobs 306 and bottom 301 is provided with ribs (not sown) offset from the positions of the knobs 306 so that boxes of the same kind can be safely supported upon each other when stacked, the knobs 306 then being inserted between the ribs.

The containers according to this exemplary embodiment can be stacked and stored to form compact blocks in warehouses, store-rooms in ships, railway cars or road trucks or on the pallets described above. In this case, the improved compressive strength and tearing strength as measured using the techniques described above, constitute an important improvement over the prior art as lightweight durable transport boxes are provided that can be stacked higher because the risk of tearing or rupture is significantly decreased.

In some embodiments of the invention, the structure can be a rectangular block. More particularly the block is used in fill applications where a lightweight material is required to reduce stresses on underlying soils or lateral pressures to retaining walls, abutments or foundations. As a specific, non-limiting example, the block can be used in geofoam applications and can be used as an embankment fill to reduce loads on underlying soils, or to build highways quickly without staged construction. The present geofoam block can be used to repair slope failures, reduce lateral load behind retaining structures, accelerate construction on fill for approach embankments, and minimize differential settlement at bridge abutments.

Geofoam blocks made according to the present invention are advantageous over prior art EPS geofoam materials due to their improved Flex Strength, Compressive Strength, Tear Strength, Tensile Strength, and/or Creep Properties as described above. These properties provide for geofoam blocks that are less prone to damage during transport and handling and are less prone to failure due to the stresses applied during and after application as a fill material.

Thus, the present invention provides a method of reducing stresses on underlying soils or lateral pressures to retaining walls that includes excavating a section of land; placing one or more blocks according to the invention over the excavated section of land; and placing filling earth over at least a portion of the blocks.

As a particular non-limiting example, FIG. 10 is a schematic view illustrating the structure of a construction section of a buried culvert according to an embodiment of the present invention. Foundation excavation is performed at a place 420, where a culvert 411 will be buried. Land grading is performed at excavated earth 421, and after that, a mat 422 and rubble stones 423 are placed for foundation treatment. Subsequently, the culvert 411 is put on the mat 422, and then, a block according to the invention 412 is placed on the top surface of the culvert 411, and filling earth 424 is banked on the placed block 412. After that, another block according to the invention 413 is placed again on the banked filling earth, filling earth 424 is banked on the placed block 413 and compacted to be equal to a final ground level 425.

Since the block 412 is located on the culvert 411, the bottom surface of the block 412 is in contact with the top surface of the culvert 411, and the top surface of the block 412 is in contact with the filling earth 424. The additionally placed block 413 is in contact with the filling earth 424 at the to and bottom surfaces thereof.

When the blocks 412 and 413 are placed in multiple layers, the block 413 placed at the upper area can be placed on a plane of equal settlement 430 of the filling earth 424 which is banked on the block 412.

When the block 412 is placed on the top surface of the culvert 411 and the filling earth 424 is filled on the top surface of the block 412, the block 412 causes artificial compression and deformation due to a vertical load of the filling earth 424, and so, earth pressure reduction due to an arching effect of earth and deformation progress arises while the banked filling earth 424 is partly settled downwardly. At this time, when the banked earth reaches a predetermined height, a plane where the filling earth 424 is no longer settled, i.e., a plane where an amount of settlement occurring by the EPS block as compressible material is 0 exists, and the plane is called the plane of equal settlement 430.

In embodiments of the invention, the structure can be an insulated concrete form (ICF). The ICF can be any type of ICF for use as is known in the art. As a non-limiting exemplary embodiment, the ICF can include a first panel member, a second panel member, and one or more connecting members. The first panel member includes at least one first slot in an inner side extending vertically therethrough. The second panel member includes at least one second slot in an inner side extending vertically therethrough. The connecting members includes a first flange detachably and securably extending within the first slot of the first panel member, a second flange detachably and securably extending within the second slot of the second panel member; and a mid-section portion that includes a plurality of pour holes spaced along its length vertically.

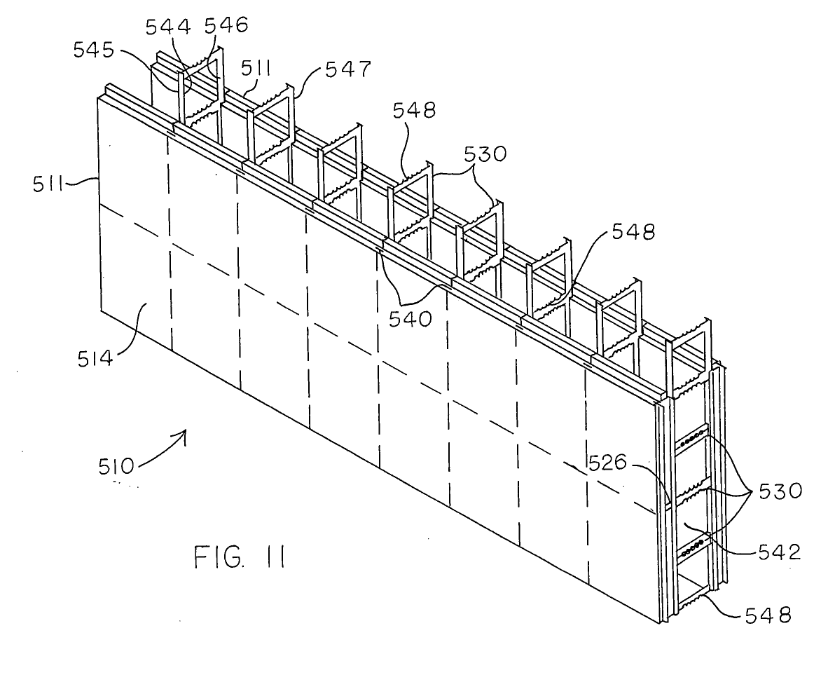

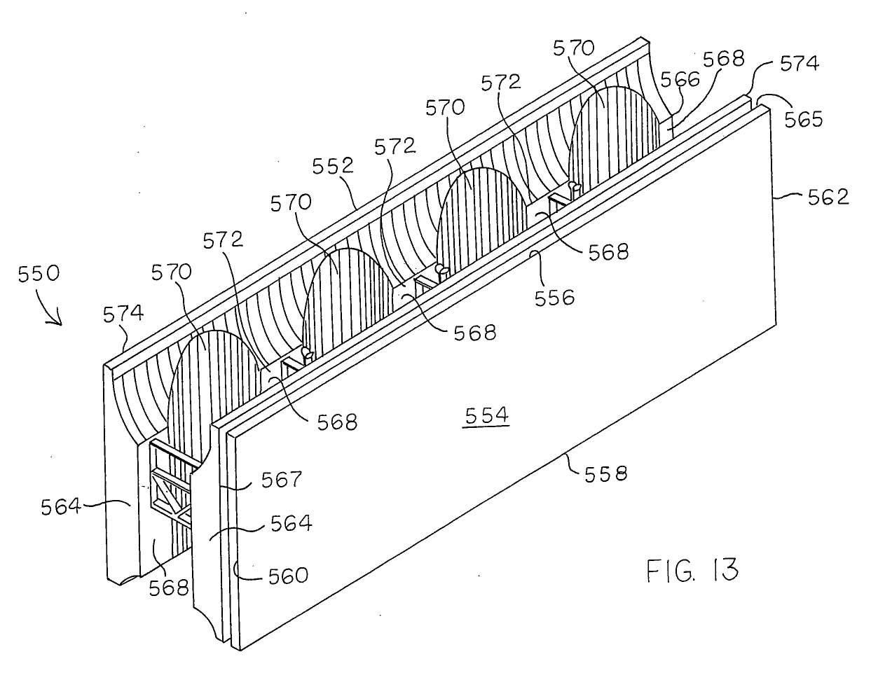

A particular exemplary embodiment is shown in FIGS. 11 and 12. A forming system for constructing insulated concrete structures is shown and includes a form unit 510 that includes panels 511 placed in an opposing and parallel relationship, with an optional facing material 514 attached to the outside surface 512 of each panel 511, and optionally a chase way 526 can be molded or cut into panels 511 to accommodate electrical wiring. A plurality of slots 540 extending from a top side of panels 511 to a bottom side of panels 511 are spaced along the length of panels 511. Connecting members 530 are located at each slot 540, sliding into and extending between the slots 540 in opposing panels 511 thereby creating a form with a cavity between the panels 511. The cavity is filled with fluid concrete to create a structure. Filling is aided as the concrete can flow through pour holes 542 in connecting members 530. Pour holes 542 are defined by a first vertical side 544 extending along a first flange 545, a second vertical side 546 extending along a second flange 547, and two horizontal braces 548. First flange detachably and securably extends within a first slot 540 of a first panel member 511 and second flange 547 detachably and securably extends within a second slot 540 of a second panel member 511. The specific structural design of the concrete structures are typically based on Uniform Building Code concrete wall designs and other accepted building codes for concrete structures.

A variety of connecting members are known in the art and the panels used in the present exemplary embodiment can be adapted to use them. Non-limiting examples of such connecting members are disclosed in U.S. Pat. Nos. 7,032,357; 6,378,260; 5,809,728; 5,890,337; 5,701,710; 4,889,310; and 4,884,382 (FIGS. 9 and 10).

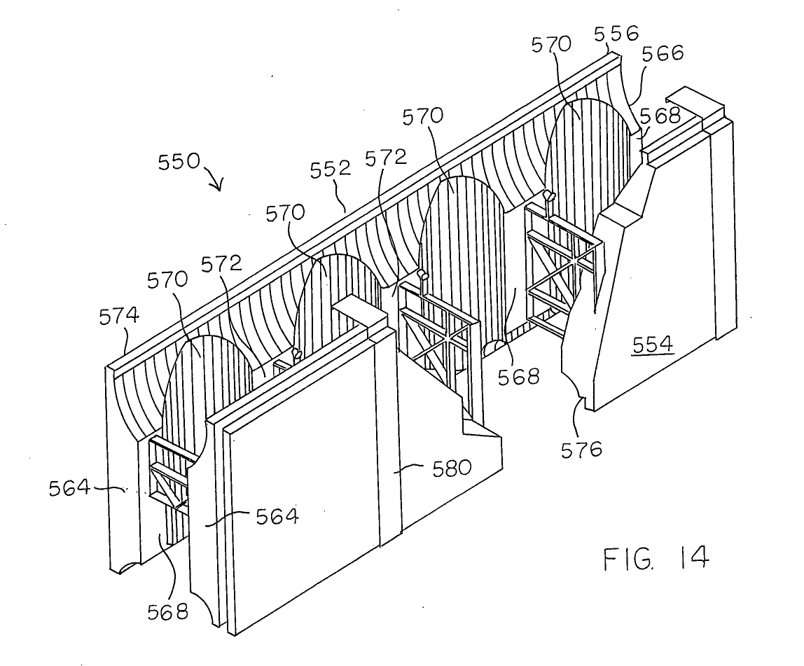

In an additional exemplary embodiment, the connecting members can be molded into the panels as shown in FIGS. 13 and 14. Concrete form 550 as includes a pair of sidewalls 552 and 554. Each sidewall has upper 556 and lower 558 longitudinal edges as well as a pair of opposed vertical edges 560 and 562. The form 550 further includes a pair of longitudinally displaced end walls 564 and 566 with intermediate longitudinally spaced-apart partition walls 568. The sidewalls 552 and 554, end walls 564 and 566 and partition walls 568 cooperate to form a plurality of vertical cavities 570 and a vertical slot 572 between the facing surfaces of the end walls 564 and 566 and partition walls 568. Slot 572 longitudinally spans the length of the form 550 and connects the cavities 570. Each form 550 has tongues 574 along the respective upper 556 edges which mate with complementary grooves 576 located along the lower edges of an overlying form 550.

At one end the end walls 564 extend beyond the sidewalls. At the opposed end the sidewalls 552 and 554 extend beyond the end wall 566. Thus, lap joint surfaces are formed. The sidewall extensions 565 at one end of one form overlap the end wall extensions 567 of an adjacent form when joined in a longitudinally adjacent relationship. Accordingly, the forms 550 can be connected in longitudinally extending courses and stacked one atop the other.

Upon reaching a desired height of the form courses wet concrete is poured between the form sidewalls 552 and 554. (It is understood that the forms are staggered among rows so as to preclude formation of a continuous vertical joint among the form rows.) The poured concrete fills the vertical cavities 570 and longitudinally extending vertical slot 572 of each form. Also, upon stacking a second course of forms atop the first a horizontal channel is formed which spans the upper and lower forms. The poured concrete will fill the channel of the form. Thus, a concrete wall within slot 572, concrete piers within cavities 570 and a horizontal beam of concrete within the channel is presented. The forms 550 are left in place for insulating the resulting concrete wall. Wall clips 580 are shown for attaching exterior siding thereto.

It is known that the courses of the forms may be selectably configured so as to present walls of various configurations. Also, door frames, window frames, bucks, bulkheads, and the like may interrupt the courses of forms so as to provide openings for insertion of doors, windows and the like therein while precluding spillage of poured concrete from the forms.

During the pouring of the concrete a hydraulic concrete load acts on the sidewalls 552 and 554 of each form 550 as well as on any structure spanning such sidewalls 552 and 554. In the prior art, the load can cause sidewalls 552 and 554 to deform from their proper vertical, lateral and longitudinal spatial relationships. Also during form transport to a job site, the sidewalls 552 and 554 have been known to deform due to the weight of other forms stacked thereon. The superior physical properties of the present structures, when used as ICF panels, act to minimize such deformations, a significant improvement over the prior art. Accordingly, problems that have existed when attempting to longitudinally and vertically connect the forms, such as the mating lap joint surfaces and/or tongue/groove elements not being properly aligned are minimized when this exemplary embodiment is employed.

In another exemplary embodiment of the invention, the structure is an insulated concrete form that includes a rectangular foamed plastic body that includes one or more beam forms and one or more column forms. The one or more beam forms are defined by a first wall adjacent to and extending along a first side of the body, a second wall adjacent to and extending along a second side of the body, and a form bottom extending from a bottom edge of the first wall to a bottom edge of the second wall. The one or more column forms extend generally parallel to the first side and the second side of the body and include a plurality of column walls extending from a top side of the body to a bottom side of the body.

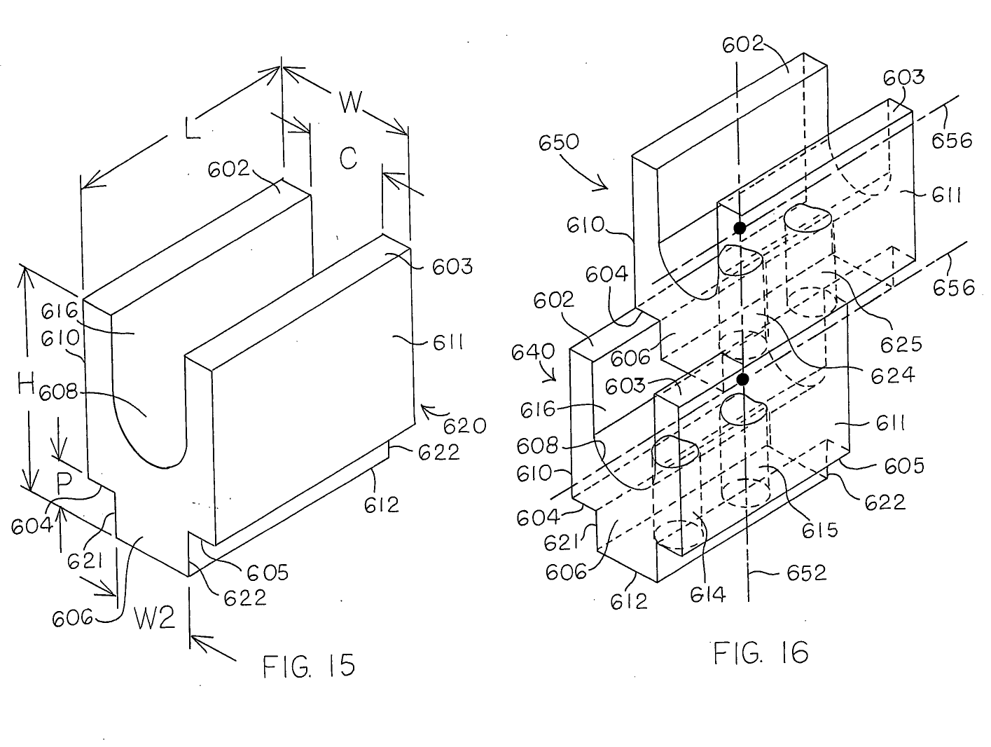

A particular exemplary embodiment is shown in FIGS. 15 and 16. A construction block 620 in the general form of a rectangular solid having a length dimension L, a width dimension W, and a height dimension H. A channel element 616 extends along the entire length dimension of block 620, where the contour at the bottom portion 608 of the channel element is shaped as a semi-circle although blocks having other contours, such as those comprising a square-shaped bottom portion, are contemplated herein. By virtue of this hollowed out channel element, having a width C, block 620 appears almost unshaped, with the exception of the protruding bottom portion 606, having width W2, which protruding bottom portion extends along the entire length of block 620 at its flat bottom 612. There are flat top surfaces 602 and 603 on each of the tines of the imaginary “U” which transverse the entire length of block 620 at its top. The protruding bottom portion 606 may be thought of as “protruding” downward from the flat shoulder surfaces 604 and 605 a distance equal to P, and is defined by intersecting shoulder notch portions having surfaces which extend along the entire length dimension of block 620. The shoulder notch portions are themselves defined by the flat shoulder surfaces 604 and 605 and 621 and 622 that are adjacent to the protruding bottom portion 606. Thus the intersection of 604 and 621 define a first shoulder notch and the intersection of 605 and 622 define a second shoulder notch. Thus, there is a shoulder notch portions disposed on each side of said protruding portion. The flat shoulder surfaces 604 and 605 can be flat surfaces which are parallel to the flat top surfaces 602 and 603 on the top portion of the block, and the surfaces 621 and 622 are oriented perpendicular to the flat shoulder surfaces 604 and 605 at their intersection. Surfaces 621 and 622 can be parallel to the front and rear face portions 610 and 611. The flat shoulder surfaces 604 and 605 are conveniently considered to be horizontal shoulder surfaces and the surfaces 621 and 622 are conveniently considered to be vertical shoulder surfaces for purposes of the invention, as these are disposed horizontally and vertically, respectively, with regard the height dimension of block 620.

In FIG. 14 is shown a staggered configuration of blocks 620 in adjacent successive rows in a wall construction that includes blocks 620 having holes disposed in bottom portion 608 of the channel element and passing through to the exterior of block 620 through flat bottom portion 612. An element of the construction is the spacing of the holes 614, 615, 624, and 625 which can be such that a hole in lower block 640 such as 615 is disposed directly beneath hole 624 of top block 650, which blocks are stacked in a staggered configuration. By such advantageous spacing, a single channel is formed from the vertical alignment of holes 624 and 615 in which a single vertically-oriented rebar such as 652 can be caused to reside. Since blocks according to this exemplary embodiment are typically placed end to end in each successive layer of a wall construction made from such blocks, such an arrangement inherently provides for a series of vertical channels to exist along the interior of a wall comprised of such blocks, along the wall's entire length. Thus, rebar may be caused to reside in each of said vertical channels. Further, since blocks according to the invention are typically placed end to end in each successive layer of a wall construction made from such blocks, such an arrangement inherently provides for a single horizontal channel to exist along the entire length of a wall made from the blocks according to the invention, at every level of block. These combined aspects provide for a wall construction that includes an interlocked stacked arrangement that is internally reinforced by a two-dimensional network of rebars around which concrete can be readily caused to exist, by pouring an un-set concrete, to provide a rigid wall. Such wall is additionally reinforced in the third dimension by the interlocking feature provided by the protruding portion 606 of a given block engaging in the channel 616 of a block beneath it and/or by the similar interaction of it with its channel portion and the protruding portion of a block above it.

Additionally, horizontal rebar 656 can be placed in channel 616 and can be fixed to vertical rebar 652, which can all subsequently be encased in concrete in a final construct of a wall using the blocks according to this exemplary embodiment of the invention. Thus, concrete fills the vertical channels defined by the alignment of the holes of successively staggered stacked blocks and the horizontal channels. The concrete also fills the vertical and horizontal channels surrounding vertical rebar 652 and horizontal rebar 656.

As an added optional step in the construction of a wall from a plurality of blocks according to the invention, a mortar, cement, concrete, or other adhesive or binding substance known to those skilled in the construction art may be applied to any of flat top surfaces 602 and 603, or the flat shoulder surfaces 604 and 605, the flat shoulder surfaces 621 and 622, or the end portions of blocks during their engagement during construction of a wall, in order to increase the strength of the wall.

Any suitable type of concrete can be used to make the concrete walls and concrete wall systems described herein. The specific type of concrete will depend on the desired and designed properties of the concrete walls and concrete wall systems. In embodiments of the invention, the concrete includes one or more hydraulic cement compositions selected from Portland cements, pozzolana cements, gypsum cements, aluminous cements, magnesia cements, silica cements, and slag cements.

In an embodiment of the invention, the concrete includes a hydraulic cement composition. The hydraulic cement composition can be present at a level of at least 3, in certain situations at least 5, in some cases at least 7.5, and in other cases at least 9 volume percent and can be present at levels up to 40, in some cases up to 35, in other cases up to 32.5, and in some instances up to 30 volume percent of the cement mixture. The concrete can include the hydraulic cement composition at any of the above-stated levels or at levels ranging between any of levels stated above.

In an embodiment of the invention, the concrete mixture can optionally include other aggregates and adjuvants known in the art including but not limited to sand, additional aggregate, plasticizers and/or fibers. Suitable fibers include, but are not limited to glass fibers, silicon carbide, aramid fibers, polyester, carbon fibers, composite fibers, fiberglass, metal and combinations thereof as well as fabric containing the above-mentioned fibers, and fabric containing combinations of the above-mentioned fibers.

Non-limiting examples of fibers that can be used in the invention include MeC-GRID® and C-GRID® available from TechFab, LLC, Anderson, S.C., KEVLAR® available from E.I. du Pont de Nemours and Company, Wilmington, Del., TWARON® available from Teijin Twaron B.V., Arnheim, the Netherlands, SPECTRA® available from Honeywell International Inc., Morristown, N.J., DACRON® available from Invista North America S.A.R.L. Corp. Wilmington, Del., and VECTRAN® available from Hoechst Celanese Corp., New York, N.Y. The fibers can be used in a mesh structure, intertwined, interwoven, and oriented in any desirable direction.

In a particular embodiment of the invention fibers can make up at least 0.1, in some cases at least 0.5, in other cases at least 1, and in some instances at least 2 volume percent of the concrete composition. Further, fibers can provide up to 10, in some cases up to 8, in other cases up to 7, and in some instances up to 5 volume percent of the concrete composition. The amount of fibers is adjusted to provide desired properties to the concrete composition. The amount of fibers can be any value or range between any of the values recited above.

Further to this embodiment, the additional aggregate can include, but is not limited to, one or more materials selected from common aggregates such as sand, stone, and gravel. Common lightweight aggregates can include ground granulated blast furnace slag, fly ash, glass, silica, expanded slate and clay; insulating aggregates such as pumice, perlite, vermiculite, scoria, and diatomite; light-weight aggregate such as expanded shale, expanded slate, expanded clay, expanded slag, fumed silica, pelletized aggregate, extruded fly ash, tuff, and macrolite; and masonry aggregate such as expanded shale, clay, slate, expanded blast furnace slag, sintered fly ash, coal cinders, pumice, scoria, and pelletized aggregate.

When included, the other aggregates and adjuvants are present in the concrete mixture at a level of at least 0.5, in some cases at least 1, in other cases at least 2.5, in some instances at least 5 and in other instances at least 10 volume percent of the concrete mixture. Also, the other aggregates and adjuvants can be present at a level of up to 95, in some cases up to 90, in other cases up to 85, in some instances up to 65 and in other instances up to 60 volume percent of the concrete mixture. The other aggregates and adjuvants can be present in the concrete mixture at any of the levels indicated above or can range between any of the levels indicated above.

In embodiments of the invention, the concrete compositions can contain one or more additives, non-limiting examples of such being anti-foam agents, water-proofing agents, dispersing agents, set-accelerators, set-retarders, plasticizing agents, superplasticizing agents, freezing point decreasing agents, adhesiveness-improving agents, and colorants. The additives are typically present at less than one percent by weight with respect to total weight of the composition, but can be present at from 0.1 to 3 weight percent.

Suitable dispersing agents or plasticizers that can be used in the invention include, but are not limited to hexametaphosphate, tripolyphosphate, polynaphthalene sulphonate, sulphonated polyamine and combinations thereof.

Suitable plasticizing agents that can be used in the invention include, but are not limited to polyhydroxycarboxylic acids or salts thereof, polycarboxylates or salts thereof; lignosulfonates, polyethylene glycols, and combinations thereof.

Suitable superplasticizing agents that can be used in the invention include, but are not limited to alkaline or earth alkaline metal salts of lignin sulfonates; lignosulfonates, alkaline or earth alkaline metal salts of highly condensed naphthalene sulfonic acid/formaldehyde condensates; polynaphthalene sulfonates, alkaline or earth alkaline metal salts of one or more polycarboxylates (such as poly(meth)acrylates and the polycarboxylate comb copolymers described in U.S. Pat. No. 6,800,129, the relevant portions of which are herein incorporated by reference); alkaline or earth alkaline metal salts of melamine/formaldehyde/sulfite condensates; sulfonic acid esters; carbohydrate esters; and combinations thereof.

Suitable set-accelerators that can be used in the invention include, but are not limited to soluble chloride salts (such as calcium chloride), triethanol-amine, paraformaldehyde, soluble formate salts (such as calcium formate), sodium hydroxide, potassium hydroxide, sodium carbonate, sodium sulfate, 12CaO.7Al₂O₃, sodium sulfate, aluminum sulfate, iron sulfate, the alkali metal nitrate/sulfonated aromatic hydrocarbon aliphatic aldehyde condensates disclosed in U.S. Pat. No. 4,026,723, the water soluble surfactant accelerators disclosed in U.S. Pat. No. 4,298,394, the methylol derivatives of amino acids accelerators disclosed in U.S. Pat. No. 5,211,751, and the mixtures of thiocyanic acid salts, alkanolamines, and nitric acid salts disclosed in U.S. Pat. No. Re. 35,194, the relevant portions of which are herein incorporated by reference, and combinations thereof.

Suitable set-retarders that can be used in the invention include, but are not limited to lignosulfonates, hydroxycarboxylic acids (such as gluconic acid, citric acid, tartaric acid, maleic acid, salicylic acid, glucoheptonic acid, arabonic acid, acid, and inorganic or organic salts thereof such as sodium, potassium, calcium, magnesium, ammonium and triethanol-amine salt), cardonic acid, sugars, modified sugars, phosphates, borates, silico-fluorides, calcium bromate, calcium sulfate, sodium sulfate, monosaccharides such as glucose, fructose, galactose, saccharose, xylose, apiose, ribose and invert sugar, oligosaccharides such as disaccharides and trisaccharides, such oligosac-charides as dextrin, polysaccharides such as dextran, and other saccharides such as molasses containing these; sugar alcohols such as sorbitol; magnesium silicofluoride; phosphoric acid and salts thereof, or borate esters; aminocarboxylic acids and salts thereof; alkali-soluble proteins; humic acid; tannic acid; phenols; polyhydric alcohols such as glycerol; phosphonic acids and derivatives thereof, such as aminotri(methylenephosphonic acid), 1-hydroxyethyl-idene-1,1-diphosphonic acid, ethylenediamine-tetra(methylenephosphonic acid), diethylenetriamine-penta(methylenephosphonic acid), and alkali metal or alkaline earth metal salts thereof, and combinations of the set-retarders indicated above.

Suitable defoaming agents that can be used in the invention include, but are not limited to silicone-based defoaming agents (such as dimethylpolysiloxane, diemthylsilicone oil, silicone paste, silicone emulsions, organic group-modified polysiloxanes (polyorganosiloxanes such as dimethylpolysiloxane), fluorosilicone oils, etc.), alkyl phosphates (such as tributyl phosphate, sodium octylphosphate, etc.), mineral oil-based defoaming agents (such as kerosene, liquid paraffin, etc.), fat- or oil-based defoaming agents (such as animal or vegetable oils, sesame oil, castor oil, alkylene oxide adducts derived there from, etc.), fatty acid-based defoaming agents (such as oleic acid, stearic acid, and alkylene oxide adducts derived there from, etc.), fatty acid ester-based defoaming agents (such as glycerol monoricinolate, alkenylsuccinic acid derivatives, sorbitol monolaurate, sorbitol trioleate, natural waxes, etc.), oxyalkylene type defoaming agents, alcohol-based defoaming agents: octyl alcohol, hexadecyl alcohol, acetylene alcohols, glycols, etc.), amide-based defoaming agents (such as acrylate polyamines, etc.), metal salt-based defoaming agents (such as aluminum stearate, calcium oleate, etc.) and combinations of the above-described defoaming agents.

Suitable freezing point decreasing agents that can be used in the invention include, but are not limited to ethyl alcohol, calcium chloride, potassium chloride, and combinations thereof.

Suitable adhesiveness-improving agents that can be used in the invention include, but are not limited to polyvinyl acetate, styrene-butadiene, homopolymers and copolymers of (meth)acrylate esters, and combinations thereof.

Suitable water-repellent or water-proofing agents that can be used in the invention include, but are not limited to fatty acids (such as stearic acid or oleic acid), lower alkyl fatty acid esters (such as butyl stearate), fatty acid salts (such as calcium or aluminum stearate), silicones, wax emulsions, hydrocarbon resins, bitumen, fats and oils, silicones, paraffins, asphalt, waxes, and combinations thereof. Although not used in many embodiments of the invention, when used suitable air-entraining agents include, but are not limited to vinsol resins, sodium abietate, fatty acids and salts thereof, tensides, alkyl-arylsulfonates, phenol ethoxylates, lignosulfonates, and mixtures thereof.

In some embodiments of the invention, the concrete is light-weight concrete. As used herein, the term “light weight concrete” refers to concrete where light-weight aggregate is included in a cementitous mixture. Exemplary light weight concrete compositions that can be used in the present invention are disclosed in U.S. Pat. Nos. 3,021,291, 3,214,393, 3,257,338, 3,272,765, 5,622,556, 5,725,652, 5,580,378, and 6,851,235, JP 9 071 449, WO 98 02 397, WO 00/61519, and WO 01/66485 the relevant portions of which are incorporated herein by reference.

In particular embodiments of the present invention, the lightweight concrete (LWC) composition includes a concrete mixture and polymer particles, a non-limiting example of which is disclosed in U.S. Patent Application Publication 2006/0225618 A1, the relevant disclosure of which is hereby incorporated by reference. In many instances the size, composition, structure, and physical properties of expanded polymer particles, and in some instances their resin bead precursors, can greatly affect the physical properties of LWC used in the invention. Of particular note is the relationship between bead size and expanded polymer particle density on the physical properties of the resulting LWC wall.

The polymer particles, which can optionally be expanded polymer particles, are present in the LWC composition at a level of at least 10, in some instances at least 15, in other instances at least 20, in particular situations up to 25, in some cases at least 30, and in other cases at least 35 volume percent and up to 90, in some cases up to 85, in other cases up to 78, in some instances up to 75, in other instance up to 65, in particular instances up to 60, in some cases up to 50, and in other cases up to 40 volume percent based on the total volume of the LWC composition. The amount of polymer particles will vary depending on the particular physical properties desired in a finished LWC wall. The amount of polymer particles in the LWC composition can be any value or can range between any of the values recited above.

The polymer particles in the lightweight concrete can include any particles derived from any suitable expandable thermoplastic material. The actual polymer particles are selected based on the particular physical properties desired in a finished LWC wall. As a non-limiting example, the polymer particles, which can optionally be expanded polymer particles, can include one or more polymers selected from homopolymers of vinyl aromatic monomers; copolymers of at least one vinyl aromatic monomer with one or more of divinylbenzene, conjugated dienes, alkyl methacrylates, alkyl acrylates, acrylonitrile, and/or maleic anhydride; polyolefins; polycarbonates; polyesters; polyamides; natural rubbers; synthetic rubbers; and combinations thereof.

In an embodiment of the invention, the polymer particles in the lightweight concrete include thermoplastic homopolymers or copolymers selected from homopolymers derived from vinyl aromatic monomers including styrene, isopropylstyrene, alpha-methylstyrene, nuclear methylstyrenes, chlorostyrene, tert-butylstyrene, and the like, as well as copolymers prepared by the copolymerization of at least one vinyl aromatic monomer as described above with one or more other monomers, non-limiting examples being divinylbenzene, conjugated dienes (non-limiting examples being butadiene, isoprene, 1,3- and 2,4-hexadiene), alkyl methacrylates, alkyl acrylates, acrylonitrile, and maleic anhydride, wherein the vinyl aromatic monomer is present in at least 50% by weight of the copolymer. In an embodiment of the invention, styrenic polymers are used, particularly polystyrene. However, other suitable polymers can be used, such as polyolefins (e.g. polyethylene, polypropylene), polycarbonates, polyphenylene oxides, and mixtures thereof.

In a particular embodiment of the invention, the polymer particles in the lightweight concrete are expandable polystyrene (EPS) particles. These particles can be in the form of beads, granules, or other particles.

In the present invention, particles polymerized in a suspension process, which are essentially spherical resin beads, are useful as polymer particles or for making expanded polymer particles for use in the lightweight concrete. However, polymers derived from solution and bulk polymerization techniques that are extruded and cut into particle sized resin bead sections can also be used.

In an embodiment of the invention, resin beads (unexpanded) to be used in the lightweight concrete containing any of the polymers or polymer compositions described herein have a particle size of at least 0.2 mm, in some situations at least 0.33 mm, in some cases at least 0.35 mm, in other cases at least 0.4 mm, in some instances at least 0.45 mm and in other instances at least 0.5 mm. Also, the resin beads can have a particle size of up to 3 mm, in some instances up to 2 mm, in other instances up to 2.5 mm, in some cases up to 2.25 mm, in other cases up to 2 mm, in some situations up to 1.5 mm and in other situations up to 1 mm. In this embodiment, the physical properties of LWC walls made according to the invention have inconsistent or undesirable physical properties when resin beads having particle sizes outside of the above described ranges are used to make the expanded polymer particles. The resin beads used in this embodiment can be any value or can range between any of the values recited above.

The expandable thermoplastic particles or resin beads used in the lightweight concrete can optionally be impregnated using any conventional method with a suitable blowing agent. As a non-limiting example, the impregnation can be achieved by adding the blowing agent to the aqueous suspension during the polymerization of the polymer, or alternatively by resuspending the polymer particles in an aqueous medium and then incorporating the blowing agent as taught in U.S. Pat. No. 2,983,692. Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC'S, which boil at a temperature below the softening point of the polymer chosen. Mixtures of these aliphatic hydrocarbon blowing agents can also be used.

Alternatively, water can be blended with these aliphatic hydrocarbons blowing agents or water can be used as the sole blowing agent as taught in U.S. Pat. Nos. 6,127,439; 6,160,027; and 6,242,540 in these patents, water-retaining agents are used. The weight percentage of water for use as the blowing agent can range from 1 to 20%. The texts of U.S. Pat. Nos. 6,127,439, 6,160,027 and 6,242,540 are incorporated herein by reference.

The impregnated polymer particles or resin beads used in the lightweight concrete are optionally expanded to a bulk density of at least 1.75 lb/ft³ (0.028 g/cc), in some circumstances at least 2 lb/ft³ (0.032 g/cc) in other circumstances at least 3 lb/ft³ (0.048 g/cc) and in particular circumstances at least 3.25 lb/ft³ (0.052 g/cc) or 3.5 lb/ft³ (0.056 g/cc). When non-expanded resin beads are used higher bulk density beads can be used. As such, the bulk density can be as high as 40 lb/ft³ (0.64 g/cc). In other situations, the polymer particles are at least partially expanded and the bulk density can be up to 35 lb/ft³ (0.56 g/cc), in some cases up to 30 lb/ft³ (0.48 g/cc), in other cases up to 25 lb/ft³ (0.4 g/cc), in some instances up to 20 lb/ft³ (0.32 g/cc), in other instances up to 15 lb/ft³ (0.24 g/cc) and in certain circumstances up to 10 lb/ft³ (0.16 g/cc). The bulk density of the polymer particles can be any value or range between any of the values recited above. The bulk density of the polymer particles, resin beads and/or pre-puff particles is determined by weighing a known volume of polymer particles, beads and/or pre-puff particles (aged 24 hours at ambient conditions).

The expansion step is conventionally carried out by heating the impregnated beads via any conventional heating medium, such as steam, hot air, hot water, or radiant heat. One generally accepted method for accomplishing the pre-expansion of impregnated thermoplastic particles is taught in U.S. Pat. No. 3,023,175.

The impregnated polymer particles used in the lightweight concrete can be foamed cellular polymer particles as taught in U.S. Patent Application Pub. No. 2002/0117769, the teachings of which are incorporated herein by reference. The foamed cellular particles can be polystyrene that are expanded and contain a volatile blowing agent at a level of less than 14 wt. %, in some situations less than 8 wt. %, in some cases ranging from about 2 wt. % to about 7 wt. %, and in other cases ranging from about 2.5 wt. % to about 6.5 wt. % based on the weight of the polymer.

An interpolymer of a polyolefin and in situ polymerized vinyl aromatic monomers that can be included in the expanded thermoplastic resin or polymer particles in the lightweight concrete according to the invention is disclosed in U.S. Pat. Nos. 4,303,756, 4,303,757 and 6,908,949, the relevant portions of which are herein incorporated by reference.

The polymer particles in the lightweight concrete can include customary ingredients and additives, such as flame retardants, pigments, dyes, colorants, plasticizers, mold release agents, stabilizers, ultraviolet light absorbers, mold prevention agents, antioxidants, rodenticides, insect repellants, and so on. Typical pigments include, without limitation, inorganic pigments such as carbon black, graphite, expandable graphite, zinc oxide, titanium dioxide, and iron oxide, as well as organic pigments such as quinacridone reds and violets and copper phthalocyanine blues and greens.

In a particular embodiment of the invention the pigment is carbon black, a non-limiting example of such a material being EPS SILVER®, available from NOVA Chemicals Inc.

In another particular embodiment of the invention the pigment is graphite, a non-limiting example of such a material being NEOPOR®, available from BASF Aktiengesellschaft Corp., Ludwigshafen am Rhein, Germany.

When materials such as carbon black and/or graphite are included in the polymer particles, improved insulating properties, as exemplified by higher R values for materials containing carbon black or graphite (as determined using ASTM-C518), are provided. As such, the R value of the expanded polymer particles containing carbon black and/or graphite or materials made from such polymer particles are at least 5% higher than observed for particles or resulting walls that do not contain carbon black and/or graphite.

The expanded polymers in the lightweight concrete can have an average particle size of at least 0.2, in some circumstances at least 0.3, in other circumstances at least 0.5, in some cases at least 0.75, in other cases at least 0.9 and in some instances at least 1 mm and can be up to 8, in some circumstances up to 6, in other circumstances up to 5, in some cases up to 4, in other cases up to 3, and in some instances up to 2.5 mm. When the size of the expanded polymer particles is too small or too large, the physical properties of LWC walls made using the present LWC composition can be undesirable. The average particle size of the expanded polymer particles can be any value and can range between any of the values recited above. The average particle size of the expanded polymer particles can be determined using laser diffraction techniques or by screening according to mesh size using mechanical separation methods well known in the art.

In an embodiment of the invention, the polymer particles or expanded polymer particles used in the lightweight concrete have a minimum average cell wall thickness, which helps to provide desirable physical properties to LWC walls made using the present LWC composition. The average cell wall thickness and inner cellular dimensions can be determined using scanning electron microscopy techniques known in the art. The expanded polymer particles can have an average cell wall thickness of at least 0.15 μm, in some cases at least 0.2 μm and in other cases at least 0.25 μm. Not wishing to be bound to any particular theory, it is believed that a desirable average cell wall thickness results when resin beads having the above-described dimensions are expanded to the above-described densities.

In an embodiment of the invention, the polymer beads used in the lightweight concrete are optionally expanded to form expanded polymer particles such that a desirable cell wall thickness as described above is achieved. Though many variables can impact the wall thickness, it is desirable, in this embodiment, to limit the expansion of the polymer bead so as to achieve a desired wall thickness and resulting expanded polymer particle strength. Optimizing processing steps and blowing agents can expand the polymer beads to a minimum of 1.75 lb/ft³ (0.028 g/cc). This property of the expanded polymer bulk density, can be described by pcf (lb/ft³) or by an expansion factor (cc/g).

As used herein, the term “expansion factor” refers to the volume a given weight of expanded polymer bead occupies, typically expressed as cc/g.

In order to provide expanded polymer particles with desirable cell wall thickness and strength, the expanded polymer particles used in the mold units and/or in the lightweight concrete are not expanded to their maximum expansion factor; as such an extreme expansion yields particles with undesirably thin cell walls and insufficient strength. Further, the polymer beads can be expanded at least 5%, in some cases at least 10%, and in other cases at least 15% of their maximum expansion factor. However, so as not to cause the cell wall thickness to be too thin, the polymer beads are expanded up to 80%, in some cases up to 75%, in other cases up to 70%, in some instances up to 65%, in other instances up to 60%, in some circumstances up to 55%, and in other circumstances up to 50% of their maximum expansion factor. The polymer beads can be expanded to any degree indicated above or the expansion can range between any of the values recited above. Typically, the polymer beads or pre-puff beads do not further expand when formulated into the present concrete compositions and do not further expand while the concrete compositions set, cure and/or harden.

In embodiments of the invention, the pre-puff or expanded polymer particles used in the light-weight concrete typically have a cellular structure or honeycomb interior portion and a generally smooth continuous polymeric surface as an outer surface, i.e., a substantially continuous outer layer. The smooth continuous surface can be observed using scanning electron microscope (SEM) techniques at 1000× magnification. SEM observations do not indicate the presence of holes in the outer surface of the pre-puff or expanded polymer particles. Cutting sections of the pre-puff or expanded polymer particles and taking SEM observations reveals the generally honeycomb structure of the interior of the pre-puff or expanded polymer particles.

The polymer particles or expanded polymer particles used in the lightweight concrete can have any cross-sectional shape that allows for providing desirable physical properties in LWC walls. In an embodiment of the invention, the expanded polymer particles have a circular, oval or elliptical cross-section shape. In embodiments of the invention, the pre-puff or expanded polymer particles have an aspect ratio of 1, in some cases at least 1 and the aspect ratio can be up to 3, in some cases up to 2 and in other cases up to 1.5. The aspect ratio of the pre-puff or expanded polymer particles can be any value or range between any of the values recited above.

In particular embodiments of the invention, the lightweight concrete includes from 10 to 90 volume percent of a cement composition, from 10 to 90 volume percent of particles having an average particle diameter of from 0.2 mm to 8 mm, a bulk density of from 0.028 g/cc to 0.64 g/cc, an aspect ratio of from 1 to 3, and from 10 to 50 volume percent of sand and/or other fine aggregate, where the sum of components used does not exceed 100 volume percent.

Lightweight concrete compositions that are particularly useful in the present invention include those disclosed in co-pending U.S. application Ser. No. 11/387,198, the relevant portions of the disclosure are incorporated herein by reference.

When lightweight concrete is used in conjunction with the present wall forming system, the density of the mold units can be decreased further or, even greater concrete pour heights can be used at the same mold unit density.

The present invention will further be described by reference to the following examples. The following examples are merely illustrative of the invention and are not intended to be limiting. Unless otherwise indicated, all percentages are by weight.

### EXAMPLE 1

This example demonstrates making partially expanded resin beads according to the invention (Sample A).

A 350-mL pressure bottle was charged with styrene (99.96 g), divinyl benzene (0.04 g) deionized water (120 ml), benzoyl peroxide (0.4 g), tert-butyl perbenzoate (0.07 g), nucleating agent (0.2 g) and suspending agents (0.45 g). The bottle was placed in a temperature-controlled bottle polymerizer. With continuous agitation, the bottle was heated to 90° C. over 1 hour, and maintained at 90° C. for 5.5 hours. Temperature was then increased to 130° C. over 1 hour, and kept at 130° C. for 2 hours before cooling to 25° C. over 1 hour.

The resulting beads were washed, dried and re-suspended in water with additional primary suspension agent. The suspension was heated from 70-115° C. over 2.5 hours as 7.5 weight % of pentane was added to the system. The system was held at 120° C. for 6 hours to fully impregnate the resin beads. The resulting resin beads were then partially expanded using steam.

A comparative example (Sample B) was prepared in the same manner, where the monomer mixture contained 100% styrene monomer to provide partially expanded polystyrene beads.

After aging, the pre-expanded beads were placed in a closed mold and heated to 115° C. to fully expand and fuse them together. The result is a shape of foam used to produce physical testing specimens as shown below.

The following evaluations were carried out on the test specimens:

Flex Strength at 5% Strain, measured according to ASTM C 203-05 using an Model 4204 Universal Test Machine, Instron Corporation, Norwood, Mass.;

Compressive Strength at 10% Strain, measured according to ASTM D 1621-04 using an Model 4204 Universal Test Machine with a compression cage at a crosshead rate of 0.1 inch per minute based on 0.1 inch per minute for each 1 inch of specimen thickness;

Tear Strength, measured according to ASTM D 3575-00 (Suffix Letter G), which requires following ASTM D 624 using Die C; and

Tensile Strength, measured according to ASTM D 3575-00 (Suffix Letter T), which requires following ASTM D 412 using Die A.

| | Sample A | Sample B |
|---|---|---|
| Flex Strength | | |
| Sample Density (pcf) | 1.26 | 1.26 |
| Measured Value (psi) | 40.7 | 34.8 |
| Compressive Strength | | |
| Sample Density (pcf) | 1.14 | 1.14 |
| Measured Value (psi) | 14.5 | 12.4 |
| Tear Strength | | |
| Sample Density (pcf) | 1.23 | 1.23 |
| Measured Value (lb/in) | 7.4 | 4.1 |
| Tensile Strength | | |
| Sample Density (pcf) | 1.08 | 1.08 |
| Measured Value (psi) | 37.0 | 27.0 |

The data demonstrate the superior physical properties of specimens made according to the present invention where performance increased in each of Flex Strength (16.8%), Compressive Strength (16.9%), Tear Strength (77.4%) and Tensile Strength (36.9%).

### EXAMPLE 2

This example demonstrates making partially expanded resin beads according to the invention (Sample C) in a 100-gallon reactor. A monomer mixture containing 99.96 weight % styrene and 0.04 weight % divinyl benzene was suspended in an aqueous phase in the presence of 0.20 weight % of a primary inorganic suspending agent and 0.25 weight % of a secondary anionic surfactant suspending agent, based on the weight of the monomer mixture. Low and high temperature peroxide initiators were added at levels of 0.34 and 0.066 weight %, respectively. Nucleation agents were also added at levels of 0.2 weight %. The resulting suspension was heated to 90°. The first phase of the polymerization of monomer mixture to polymer was carried out at 90° C. over 5.5 hours. The suspension was then heated to 130° C. The second phase of the polymerization was carried out at 130° C. over 2 hours. The resulting beads were washed, dried and re-suspended in water with additional primary suspension agent.

A comparative example (Sample D) was prepared in the same manner, where the monomer mixture contained 100% styrene monomer to provide polystyrene beads.

The resulting beads were washed, dried and re-suspended in water with additional primary suspension agent in a 100-gallon reactor as described below (all weights are in pounds).

| Impregnation | Sample C | Sample D |
|---|---|---|
| Deionized Water | 90.5 | 90.5 |
| Washed Beads | 100 | 100 |
| Tricalcium phosphate | 1.2 | 1.2 |
| Polysorbate¹ | 0.2 | 0.2 |
| Pentane | 3.6 | 3.9 |

¹TWEEN ® 20, available from ICI Americas Inc., Bridgewater, NJ

The suspension was heated from 70-115° C. over 2.5 hours as pentane was added to the system. The system was held at 115° C. for 1.5 hours to fully impregnate the resin beads.

The impregnated resin beads were expanded using steam in a Hirsch 3000H batch pre-expander (Hirsch Maschinenbau GmbH & Co KG, Klagenfurt, Austria.

A Kohler General 606 series press was used to mold 2 ft×2 ft×2 in foam samples were molded after 4 hrs of conditioning time. The foam samples were cut into flexural and compressive physical testing specimens using a Hirsch Polycad hot-wire cutter. The specimens were prepared in accordance with ASTM C578 with molded skins on one major surface. All foam specimens were aged in a constant temperature and humidity environment for 40 hrs prior to testing. After aging, the specimens were measured and the specimen densities were calculated.

The following evaluations were carried out on the test specimens:

Flexural Modulus and Strain at Break, measured according to ASTM C 203-05 using an Model 4204 Universal Test Machine, Instron Corporation, Norwood, Mass.;

Compressive Modulus, measured according to ASTM D 1621-04 using an Model 4204 Universal Test Machine with a compression cage at a crosshead rate of 0.1 inch per minute based on 0.1 inch per minute for each 1 inch of specimen thickness; and

The Steady State Compressive Creep Rate was measured according to ASTM D 2990-01 at an applied force of 24 lbf.

| | | | | Flex | |
|---|---|---|---|---|---|
| | | Copressive | | Strain | Flexural |
| | Density | Modulus | Density | at Break | Modulus |
| Sample | (pcf) | (psi) | (pcf) | (%) | (psi) |
| C | 2.9 | 2558 | 3.0 | 3.6 | 6296 |
| D | 2.9 | 2239 | 3.0 | 3.0 | 5330 |

The Steady State Compressive Creep Rate was measured according to ASTM D 2990-01 at an applied force of 24 lbf as outlined in the table below, where the weight in grams (Wt), volume in in³ (Vol), density in lb/ft³ (D), height in inches (H), width in inches (W) and length in inches (L) were measured for the individual test specimen as indicated, SSCR is the measured Steady State Creep Rate in %/hr (all values represented as the written number times 10⁻⁶), and % is the percentage difference between each corresponding sample C (with DVD) and sample D (without DVB).

| | | | | | | | Load | Static | | |
|---|---|---|---|---|---|---|---|---|---|---|
| | Wt | Vol | D | H | W | L | Area | Stress | SSCR | % |
| C | 2.9 | 4.0 | 2.7 | 1.9 | 1 | 2.0 | 2.0 | 11.8 | 3.877 | −11.4 |
| D | 2.8 | 4.0 | 2.7 | 1.9 | 1 | 2.0 | 2.0 | 11.8 | 4.378 | |
| C | 3.8 | 5.2 | 2.7 | 2.0 | 1 | 2.5 | 2.6 | 9.3 | 3.462 | −13.8 |
| D | 3.7 | 5.2 | 2.7 | 2.0 | 1 | 2.5 | 2.6 | 9.3 | 4.017 | |
| C | 5.5 | 7.3 | 2.8 | 2.0 | 1 | 3.6 | 3.6 | 6.6 | 3.114 | −8.2 |
| D | 5.4 | 7.3 | 2.8 | 2.0 | 1 | 3.6 | 3.6 | 6.6 | 3.395 | |

The data demonstrate the superior physical properties of specimens made according to the present invention where performance increased in each of Compressive Modulus (14.2%), Flexural Strain at Break (21.9%, Flexural Modulus (18.1%) and Steady State Compressive Creep Rate decreased (from 8.2% to 13.8%) for the samples according to the invention as compared to control samples that did not include a divinyl aromatic monomer in the monomer mixture.

### EXAMPLE 3

This example demonstrates making partially expanded resin beads according to the invention (Sample F) in a 100-gallon reactor. A monomer mixture containing 99.96 weight % styrene and 0.04 weight % divinyl benzene was suspended in an aqueous phase in the presence of 0.15 weight % of a primary inorganic suspending agent and 0.002 weight % of a secondary suspending agent, based on the weight of the monomer mixture. Low and high temperature peroxide initiators were added at levels of 0.34 and 0.022 weight %, respectively. Nucleation agents were also added at levels of 0.2 weight %. The resulting suspension was heated to 90°. The first phase of the polymerization of monomer mixture to polymer was carried out at 90° C. over 4.5 hours. The suspension was then heated to 135° C. The second phase of the polymerization was carried out at 135° C. over 1 hour.

A comparative example (Sample E) was prepared in the same manner, where the monomer mixture contained 100% styrene monomer to provide polystyrene beads.

The resulting beads were washed, dried and re-suspended in water with additional primary suspension agent in a 100-gallon reactor as described below (all weights are in pounds).

| Impregnation | |
|---|---|
| Deionized Water | 90.5 |
| Washed Beads | 100 |
| Tricalcium phosphate | 1.2 |
| Polysorbate¹ | 0.2 |
| Pentane | 5.7 |

¹TWEEN ® 20, available from ICI Americas Inc., Bridgewater, NJ

The suspension was heated from 70-115° C. over 2.5 hours as pentane was added to the system. The system was held at 115° C. for 1.5 hours to fully impregnate the resin beads.

The impregnated resin beads were expanded using steam in a Hirsch 3000H batch pre-expander (Hirsch Maschinenbau GmbH & Co KG, Klagenfurt, Austria. Batches of corresponding resin beads were expanded to 1.1 pcf and 1.9 pcf.

A Kohler General 606 series press was used to mold 2 ft×2 ft×2 in foam samples were molded after 4 hrs of conditioning time. The foam samples were cut into flexural and compressive physical testing specimens using a Hirsch Polycad hot-wire cutter. The specimens were prepared in accordance with ASTM C578 with molded skins on one major surface. All foam specimens were aged in a constant temperature and humidity environment for 40 hrs prior to testing. After aging, the specimens were measured and the specimen densities were calculated.

The following evaluations were carried out on the test specimens:

Flex Strength was measured according to ASTM C 203-05 using an Model 4204 Universal Test Machine, Instron Corporation, Norwood, Mass. Compressive Strength was measured according to ASTM D 1621-04 using an Model 4204 Universal Test Machine with a compression cage at a crosshead rate of 0.1 inch per minute based on 0.1 inch per minute for each 1 inch of specimen thickness.

The flexural strain at break and compressive modulus were normalized with respect to density at 1.40 pcf and 2.00 pcf. As the table below shows, the flexural strain at break of the DVB cross-linked foam was 11.8% to 13.4% greater than the control. The compressive modulus of the DVB cross-linked foam was 21.0% to 22.7% greater than the control.

| Density, | | | | |
|---|---|---|---|---|
| pcf | Sample E | Sample F | Delta | Delta/Sample E |
| | Flex Strain at Break, | | | |
| | % | | | |
| 1.40 | 5.97 | 6.78 | 0.80 | 13.4% |
| 2.00 | 4.73 | 5.29 | 0.56 | 11.8% |
| | Compressive Modulus, | | | |
| | psi | | | |
| 1.40 | 520 | 629 | 109 | 21.0% |
| 2.00 | 856 | 1051 | 195 | 22.7% |

The present invention has been described with reference to specific details of particular embodiments thereof. It is not intended that such details be regarded as limitations upon the scope of the invention except insofar as and to the extent that they are included in the accompanying claims.

We claim:

1. A foamed plastic structure comprising one or more foamed plastic bodies comprising a polymer matrix that includes one or more polymers formed by polymerizing a monomer mixture that includes vinyl aromatic monomers and divinyl aromatic monomers.

2. The foamed plastic structure according to claim 1, wherein the vinyl aromatic monomers are selected from the group consisting of styrene, isopropylstyrene, alpha-methylstyrene, nuclear methylstyrenes, chlorostyrene, tert-butylstyrene, vinyl toluene, vinyl xylene, ethyl vinyl benzene, vinyl naphthalene, para-methyl styrene, dibromostyrene and combinations thereof and the divinyl aromatic monomers are selected from the group consisting of divinyl benzene, divinyl naphthalene, trivinyl benzene, divinyl toluene, divinyl xylene, divinyl alkyl benzenes, divinyl phenanthrene, divinyl biphenyl, divinyl diphenyl methane, divinyl benzyl, divinyl phenyl ether, divinyl diphenyl sulfide; divinyl furan; and combinations thereof.

3. The foamed plastic structure according to claim 1, wherein the monomer mixture comprises one or more other monomers selected from the group consisting of conjugated dienes, C₁-C₃₂ alkyl(meth)acrylates, acrylonitrile, maleic anhydride, C₂-C₃₂ alpha-olefins and combinations thereof.

4. The foamed plastic structure according to claim 1, wherein the polymerization forms an interpolymer of a polyolefin and in situ polymerized vinyl aromatic monomers and divinyl aromatic monomers.

5. The foamed plastic structure according to claim 1, wherein the vinyl aromatic monomers are present at a level of at least about 50 wt. % and the divinyl aromatic monomers are present at a level of from about 0.01 to about 0,07 wt. % of the monomer mixture.

6. The foamed plastic structure according to claim 3, wherein the vinyl aromatic monomers are present at from about 50 to about 99 wt. %, the other monomers are present at from about 1 to about 49 wt. %, and the divinyl aromatic monomers are present at from about 0.01 to about 0,07 wt. % of the monomer mixture.

7. The foamed plastic structure according to claim 1, wherein the vinyl aromatic monomer is styrene and the divinyl aromatic monomer is divinyl benzene.

8. The foamed plastic structure according to claim 1, wherein the polymer matrix comprises polymers formed by polymerizing a monomer mixture that includes vinyl aromatic monomers and divinyl aromatic monomers and other thermoplastic polymers and/or elastomeric materials.

9. The foamed plastic structure according to claim 8, wherein the other thermoplastic polymers are selected from the group consisting of homopolymers derived from vinyl aromatic monomers; copolymers prepared by the copolymerization of at least one vinyl aromatic monomer with one or more other monomers; and combinations thereof.

10. The foamed plastic structure according to claim 1 having a density of from about 0.5 lb/ft³ to about 12 lb/ft³.

11. The foamed plastic structure according to claim 1, wherein the structure has a Flex Strength at 5% Strain, measured according to ASTM C 203-05, that is at least 10% higher than a similarly molded structure made from the same polymer composition not containing the divinyl aromatic monomers.

12. The foamed plastic structure according to claim 1, wherein the structure has a Compressive Strength at 10% Strain, measured according to ASTM D 1621-04a, that is at least 10% higher than a similarly molded structure made from the same polymer composition not containing the divinyl aromatic monomers.

13. The foamed plastic structure according to claim 1, wherein the structure has a Tear Strength, measured according to ASTM D 624 using Die C, that is at least 10% higher than a similarly molded structure made from the same polymer composition not containing the divinyl aromatic monomers.

14. The foamed plastic structure according to claim 1, wherein the structure has a Tensile Strength, measured according to ASTM D 412 using Die A, that is at least 10% higher than a similarly molded structure made from the same polymer composition not containing the divinyl aromatic monomers.

15. The foamed plastic structure according to claim 1, wherein the structure has a Steady State Compressive Creep Rate, measured according to ASTM D 2990-01, that is at least 5% lower than a similarly molded structure made from the same polymer composition not containing the divinyl aromatic monomers.

16. The foamed plastic structure according to claim 1, wherein the structure is an insulated concrete form comprising a rectangular foamed plastic body that includes
one or more beam forms defined by a first wall adjacent to and extending along a first side of the body, a second wall adjacent to and extending along a second side of the body, and a form bottom extending from a bottom edge of the first wall to a bottom edge of the second wall; and
one or more column forms extending generally parallel to the first side and the second side of the body and comprising a plurality of column walls extending from a top side of the body to a bottom side of the body.

17. The foamed plastic structure according to claim 1, wherein the structure is an insulated concrete form comprising a first panel member, a second panel member, and one or more connecting members, wherein
(A) the first panel member comprises at least one first slot in an inner side extending vertically therethrough;
(B) the second panel member comprises at least one second slot in an inner side extending vertically therethrough; and
(C) the connecting members comprise a first flange detachably and securably extending within said first slot of said first panel member, a second flange detachably and securably extending within said second slot of said second panel member; and a mid-section portion comprising a plurality of pour holes spaced along its length vertically.

18. The foamed plastic structure according to claim 1, wherein the structure is a pallet comprising a base and a plurality of legs extending from one side of the base.

19. The foamed plastic structure according to claim 1, wherein the structure is a container, comprising:
the bottom part having a bottom wall, spaced generally parallel side walls and spaced generally parallel end walls, said side walls of said bottom part having vertical outer surfaces with tapered surfaces extending inwardly adjacent the lower portions thereof, said side walls of said bottom part having openings extending through the side walls of the bottom part and the tapered surfaces of the side walls of the bottom part, said tapered surfaces on the side walls of the bottom part having a height so that the openings in the bottom part extend solely through the tapered surfaces of the side walls of the bottom part,
the top part having a top having a top wall, spaced generally parallel side walls and spaced generally parallel end walls, said side walls of said top part having vertical outer surfaces with tapered surfaces extending inwardly adjacent the upper portions thereof, said side walls of said top part having openings extending through the side walls of the top part and the tapered surfaces of the side walls of the top part, said tapered surfaces on the side walls of the top part having a height so that the openings in the top part extend solely through the tapered surfaces of the side walls of the top part; and
cooperative mating means carried by the bottom and top parts whereby the top part is releasably secured to the bottom part to form an enclosed volume within the bottom and top parts which is ventilated by the openings in bottom and top parts.

20. The foamed plastic structure according to claim 1, wherein the structure is a container comprising:
a container portion having bottom and side walls, the upper periphery of the container side walls supporting an upwardly extending tongue therearound having a cross section with upwardly converging side surfaces; and
a closure portion having a lid panel that includes a flange therearound, the flange in cross section comprising two downwardly extending legs defining therebetween a tongue-receiving groove.

21. The foamed plastic structure according to claim 1, wherein the structure is a stackable container comprising a bottom wall, four side walls extending upwardly from the peripheral edges of the bottom wall, and flanges extending along the upper edges of at least two opposite side walls and inwardly therefrom, wherein the flanges are adapted to receive a cover.

22. The foamed plastic structure according to claim 1, wherein the structure is a transport box comprising side walls and end walls and a bottom, the side walls each having a vertical portion and an inwardly inclined upper portion, the top edge of the upper portion being horizontally turned outwardly forming a board-like support with its outer margin bent downwardly, a plurality of spaced vertical stiffening webs extending between the board-like support and the inclined upper portion, means forming tubular vertical reinforced corners at the junctures of the side and end walls, the tubular corners being closed at their tops, and a plurality of knobs on the upwardly facing surface of the board-like supports and ribs on the bottom of the box fitting between the knobs when the boxes are stacked.

23. The foamed plastic structure according to claim 1, wherein the structure is a rectangular block.

24. A method of reducing stresses on underlying soils or lateral pressures to retaining walls comprising:
excavating a section of land:
placing one or more blocks according to claim 23 over the excavated section of land; and
placing filling earth over at least a portion of the blocks.
